(19) United States
(12) Patent Application Publication
(10) Pub. No.: US 2025/0317401 A1
(43) Pub. Date: Oct. 9, 2025

(54) INTELLIGENT APPLICATION PRIORITY PACKET DELIVERY CONTROL

(71) Applicant: Adeia Guides Inc., San Jose, CA (US)

(72) Inventors: Christopher Phillips, Hartwell, GA (US); Dhananjay Lal, Englewood, CO (US); Reda Harb, Tampa, FL (US)

(21) Appl. No.: 18/667,655

(22) Filed: May 17, 2024

Related U.S. Application Data
(60) Provisional application No. 63/574,668, filed on Apr. 4, 2024.

(51) Int. Cl. H04L 47/2475; A63F 13/358; H04L 47/50

(52) U.S. Cl. CPC H04L 47/2475; A63F 13/358; H04L 47/54

(57) ABSTRACT

Systems and methods are provided for establishing a network session with a device during which network session data is provided to the device via a network. The device may be connected to an LAN, and portions of data are configured to be selectively provided to the device via the network using a first queue for preferential network traffic or a second queue for non-preferential network traffic. During the network session, the systems and methods may identify characteristic(s) of a portion of the network session data, and determine, based on the characteristic(s), whether to provide the portion of the network session data to the device using the first queue or the second queue. Based on determining to provide the portion of the network session data using the first queue, the systems and method may provide the portion of the network session data to the device using the first queue.

### CROSS-REFERENCE TO RELATED APPLICATIONS

This application claims the benefit of U.S. Provisional Application No. 63/574,668 filed Apr. 4, 2024, the disclosure of which is hereby incorporated by reference herein in its entirety.

The disclosure of commonly owned application Ser. No. 18/626,668, filed Apr. 4, 2024, and entitled “CUSTOMER-CENTRIC, APPLICATION-FLOW AWARE BROADBAND SERVICE,” (Attorney docket no. 003597-2998-101) is hereby incorporated by reference herein in its entirety. The disclosure of commonly owned application Ser. No. 18/626,659, filed Apr. 4, 2024, and entitled “APPLICATION FLOW-AWARE BROADBAND SERVICE WITH DATA CAPS,” (Attorney docket no. 003597-4007-101) is hereby incorporated by reference herein in its entirety.

### BACKGROUND

This disclosure is directed to systems and methods for determining, based on one or more characteristics of a portion of a network session data, whether to provide the portion of network session data using a first queue for preferential network traffic or a second queue for non-preferential network traffic.

### SUMMARY

When a network link is congested, latency on the network link generally increases. Traditionally, this has often occurred primarily because of certain congestion control mechanisms utilized by a sender transmitting data on the network link, rather than due to a lack of available capacity on the network link. Such congestion control mechanisms attempt to detect currently available capacity on the network link, to allow the sender to adjust its data transmission rate accordingly. However, such congestion control mechanisms often cause queuing delay, e.g., application providers often send data too quickly for the network to queue it up.

For example, as stated in Internet Engineering Task Force (IETF), “Low Latency, Low Loss, and Scalable Throughput (L4S) Internet Service: Architecture,” RFC 9330, January 2023, (referred to herein as RFC 9330), the contents of which are hereby incorporated by reference herein in their entirety, “queuing remains a major, albeit intermittent, component of latency. For instance, spikes of hundreds of milliseconds are not uncommon, even with state-of-the-art Active Queue Management (AQM) . . . . It has been demonstrated that, once access network bit rates reach levels now common in the developed world, increasing link capacity offers diminishing returns if latency (delay) is not addressed.” RFC 9330 further states that “Queuing delay degrades performance intermittently . . . . It occurs i) when a large enough capacity-seeking (e.g., TCP) flow is running alongside the user's traffic in the bottleneck link, which is typically in the access network, or ii) when the low latency application is itself a large capacity-seeking or adaptive rate flow (e.g., interactive video).”

The L4S standard has been introduced to help address these issues. As stated in RFC 9330, “This document describes the L4S architecture, which enables Internet applications to achieve low queuing latency, low congestion loss, and scalable throughput control. L4S is based on the insight that the root cause of queuing delay is in the capacity-seeking congestion controllers of senders, not in the queue itself. With the L4S architecture, all Internet applications could (but do not have to) transition away from congestion control algorithms that cause substantial queuing delay and instead adopt a new class of congestion controls that can seek capacity with very little queuing. These are aided by a modified form of Explicit Congestion Notification (ECN) from the network. With this new architecture, applications can have both low latency and high throughput. The architecture primarily concerns incremental deployment. It defines mechanisms that allow the new class of L4S congestion controls to coexist with ‘Classic’ congestion controls in a shared network. The aim is for L4S latency and throughput to be usually much better (and rarely worse) while typically not impacting Classic performance.”

Traditional single-queue buffering of Internet packets at a network component such as an access network router suffers from Head-of-line (HoL) blocking, effectively making high latency-sensitive traffic wait in a queue behind less latency-sensitive traffic, which adversely affects the customer's quality of experience (QoE). The L4S mechanism helps address this issue using dual queueing in the wide area network (WAN), with one queue dedicated to low latency packets and the other queue dedicated to classic traffic, and makes reasonable assumptions about performance of network-dependent low latency applications such as gaming, AR/VR, voice, etc. to deliver an improved service.

However, while L4S attempts to do justice to highly latency-sensitive applications, it does not provide for treating different portions of a same network session (e.g., a video game) differently based on their characteristics. For example, L4S may process all video game traffic in a preferential manner, even if certain portions of the video game (e.g., a menu screen) may not need preferential treatment as such portions may not be critical to the QoE. This may cause finite network resources to be dedicated to portions of a network session to facilitate preferential treatment of such portions, even though such portion may be sufficiently provided in a non-preferential manner without impacting the QoE, on the basis that other portions of the network session require the preferential treatment, which may not be an optimal use of network resources. What is needed is a context-aware mechanism for selectively treating portions of the same network traffic session as preferential or non-preferential, based on real-time analysis of the user's current network session.

To help overcome these issues, systems, apparatuses, and methods are provided herein for receiving, via a network, a request from a device connected to a local area network (LAN), wherein portions of data are configured to be selectively provided to the device via the network using a first queue for preferential network traffic or a second queue for non-preferential network traffic; based on the request, establishing a network session with the device during which network session data is provided to the device via the network; during the network session: identifying one or more characteristics of a portion of the network session data; determining, based on the one or more characteristics of the portion of the network session data, whether to provide the portion of the network session data to the device using the first queue or the second queue; and based on determining to provide the portion of the network session data using the first queue, providing the portion of the network session data to the device using the first queue. Such aspects enable network resources (e.g., latency priority) to be conserved for portions of a network session for which the network resources will have the most impact on the user experience (e.g., combat portions of a video game), by treating portions of the network traffic (e.g., portions of the video game such as a menu, advertisement, or cut scene) less likely to impact the user experience as non-preferential (e.g., not given latency priority).

In some embodiments, identifying the one or more characteristics of the portion of the network session data comprises determining the portion of the network session data is latency sensitive; determining whether to provide the portion of the network session data to the device using the first queue or the second queue is based on whether the portion of the network session data is latency sensitive; and based on determining that the portion of the network session data is latency sensitive, providing the portion of the network session data to the device using the first queue.

In some embodiments, the network session comprises a video gaming session and the network session data comprises data for a video game played by a user of the device during the video gaming session; and determining whether the portion of the network session data is latency sensitive comprises determining whether the portion of the network session data corresponds to one or more characters within the video game being controlled by the user or to a cutscene or menu screen of the video game.

In some embodiments, determining whether the portion of the network session data is latency sensitive is further based at least in part on at least one of a type of the video game or a type of a video game portion in which the one or more characters are being controlled by the user.

In some embodiments, the determining whether the portion of the network session data is latency sensitive is based at least in part on identifying metadata associated with the video game and determining whether the metadata indicates that the portion of the network session data corresponds to a portion of the video game that is latency sensitive. In some embodiments, the determining whether the portion of the network session data is latency sensitive is based at least in part on a game engine calling APIs on the sender/transmission system.

In some embodiments, determining whether to provide the portion of the network session data to the device using the first queue or the second queue based at least in part on a bandwidth of the network and a jitter associated with providing the portion of the network session data over the network.

In some embodiments, the network session data is provided by an application service provider during the network session, and the portion of the network session data is a first portion; and the systems and methods may be further configured to identify one or more characteristics of a second portion of the network session data; determine, based on the one or more characteristics of the second portion of the network session data, whether to provide the second portion of the network session data to the device using the first queue or the second queue; and based on determining to provide the second portion of the network session data using the second queue, provide the second portion of the network session data to the device using the second queue.

In some embodiments, identifying the one or more characteristics of the portion of the network session data comprises determining a threshold level of localization accuracy or a threshold level of localization precision required for the portion of the network session data; and determining to provide the portion of the network session data using the first queue based on determining the localization accuracy required for the portion of the network session data exceeds the threshold level of localization accuracy or the localization precision required for the portion of the network session data exceeds the threshold level of precision. In some embodiments, a frequency of localization updates may be increased based at least in part on determining that a portion of network session data is latency sensitive, and/or based at least in part on determining that the localization precision exceeds the threshold level of precision, and/or based at least in part on determining that the localization accuracy exceeds the threshold level of accuracy.

In some embodiments, determining the localization accuracy required for the portion of the network session data exceeds the threshold level of localization accuracy or the localization precision required for the portion of the network session data exceeds the threshold level of precision based on at least one of a proximity of the device to one or more objects in an environment of the device or a speed of the device.

In some embodiments, the device is an extended reality (XR) device, and the systems and methods further comprise causing data transmitted by the XR device to be provided to a remote server using the first queue, based at least in part on the determining that the localization accuracy required for the portion of the network session data exceeds the threshold level of localization accuracy or the localization precision required for the portion of the network session data exceeds the threshold level of precision.

In some embodiments, causing data transmitted by the device to be provided to a remote server using the first queue is further performed based on determining a distance between a user wearing the XR device and a physical object in an XR environment surrounding the user, and/or based on determining a distance between a user wearing the XR device and a virtual object in the XR environment surrounding the user, and/or based on determining a distance between the virtual object in relation to other objects in the XR environment. In some embodiments, causing data transmitted by the device to be provided to a remote server using the first queue for preferential network traffic is further based on determining whether one or more virtual objects rendered by the XR device are within a threshold distance of a physical object in an environment surrounding the XR device. In some embodiments, causing data transmitted by the device to be provided to a remote server using the first queue is further performed based at least in part on whether the XR device is located indoors and not outdoors.

In some embodiments, based on determining to provide the portion of the network session data using the first queue, the systems and methods disclosed herein may cause bits of the portion of the network session data to be marked with an indication that the portion of the network session data is to be provided to the device using the first queue.

In some embodiments, the first queue is for the preferential network traffic is for low latency, low loss, and scalable throughput (L4S) network traffic.

In some embodiments, the network session comprises a multiplayer video gaming session in which users of a plurality of devices, including the device and one or more other devices, are playing a video game with each other over the network; the one or more other devices are remote from the device of the LAN; and the systems and methods disclosed herein further comprise, based on determining that a particular device of the other devices is not capable of being provided data over the network using the first queue, providing data to each of the plurality of devices using the first queue for a remainder of the network session.

In some embodiments, determining that the particular device of the other devices is not capable of being provided data over the network using the first queue comprises analyzing a network packet received from the particular device.

In some embodiments, the device is a robotic device, and the systems and methods further comprise causing data transmitted by the device to be provided to a remote server using the first queue for preferential network traffic is based on determining whether one or more objects are within a threshold distance of the robotic device.

In some embodiments, the device is associated with a controller, and the systems and methods further comprise further causing network session data, corresponding to input received via the controller in relation to the portion of the network session data, to be processed using the first queue for preferential network traffic.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative architecture for a system for processing network traffic, in accordance with some embodiments of this disclosure.

FIGS. 2A-2B show illustrative block diagrams for providing a dual queue service configuration, in accordance with some embodiments of this disclosure.

FIG. 3 shows an illustrative diagram of network traffic in a system, in accordance with some embodiments of this disclosure.

FIG. 4 shows illustrative marking of explicit congestion notification (ECN) bits, in accordance with some embodiments of this disclosure.

FIG. 5 shows an example of selectively treating portions of data as preferential or non-preferential during a network session, in accordance with some embodiments of this disclosure.

FIG. 6 shows an illustrative architecture of a system for selectively treating portions of data as preferential or non-preferential during a network session, in accordance with some embodiments of this disclosure.

FIG. 7 shows an illustrative architecture of a system for selectively treating portions of data as preferential or non-preferential during a network session, in accordance with some embodiments of this disclosure.

FIG. 8 shows an illustrative architecture for a system for selectively transmitting data using a preferential queue or a non-preferential queue, during a multiplayer session for multiplayer gaming, in accordance with some embodiments of this disclosure.

FIG. 9 is an illustrative example of using SLAM on an XR headset (e.g., indoors or outdoors), enabling a virtual objects to interact at close range with the physical world, to facilitate relatively more precise localization, in accordance with some embodiments of this disclosure.

FIG. 10 is an example of using SLAM on a device (e.g., indoors or outdoors) to enable a virtual object to interact at a large distance with the physical world, to facilitate relatively less precise localization, in accordance with some embodiments of this disclosure.

FIG. 11A is an example of using SLAM to transmit network traffic associated with a robotic lawn mower when there are physical objects close to the robotic lawn mower, in accordance with some embodiments for this disclosure.

FIG. 11B is an example of using SLAM to transmit network traffic associated with a robotic lawn mower when there are no physical objects, or minimal physical objects, close to the robotic lawn mower, in accordance with some embodiments for this disclosure.

FIG. 12 is an illustrative architecture for a system having interfaces with SLAM functionalities and/or sub-functionalities, for enabling L4S in a XR device using cloud-based SLAM, in accordance with some embodiments for this disclosure.

FIG. 13 is an illustrative architecture for a system having interfaces with SLAM functionalities and/or sub-functionalities, for enabling L4S in a robotic device using cloud-based SLAM, in accordance with some embodiments for this disclosure.

FIG. 14 is an illustrative architecture for a system for selectively treating portions of network traffic preferentially during a virtual conference, in accordance with some embodiments for this disclosure.

FIG. 15A-15B show illustrative examples for selectively treating portions of network traffic preferentially when remotely controlling construction equipment, in accordance with some embodiments for this disclosure.

FIG. 16 shows an illustrative architecture for a system for prioritized stream delivery with L4S based on remote vehicle control with proximity of objects, in accordance with some embodiments of this disclosure.

FIG. 17 shows a flowchart of an illustrative process for selectively enabling L4S for a video streaming request based on whether it is for a live view of an on-premises camera, in accordance with some embodiments of this disclosure.

FIG. 18 shows a flowchart of an illustrative process for selectively enabling L4S for a video streaming request based on priority metadata of the video, in accordance with some embodiments of this disclosure.

FIG. 19 shows an illustrative example of selectively treating network traffic as preferential in the context of placing wagers over a network, in accordance with some embodiments of this disclosure.

FIGS. 20-21 show illustrative devices and systems for selectively treating portions of network traffic preferentially, in accordance with some embodiments of this disclosure.

FIG. 22 is a flowchart of a detailed illustrative process for preferential treatment of portions of network traffic, in accordance with some embodiments of this disclosure.

### DETAILED DESCRIPTION

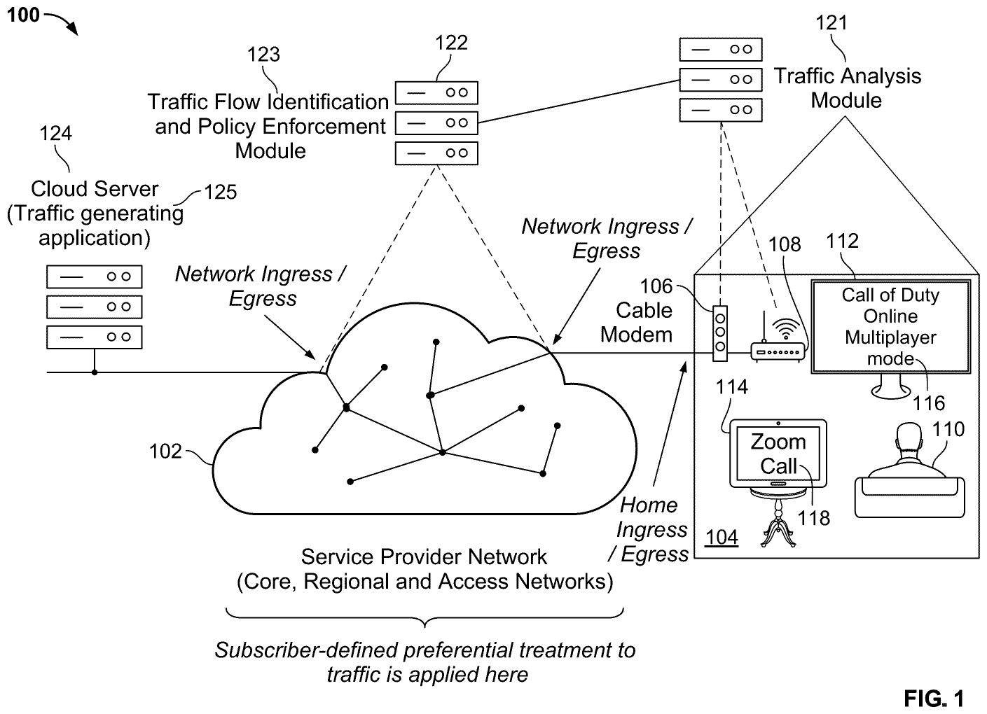

FIG. 1 shows an illustrative architecture for processing network traffic, in accordance with some embodiments of this disclosure. System 100 may comprise service provider network 102, physical location 104 (e.g., a home of user 110, a place of business, a school, or any other suitable location, or any combination thereof), networking equipment 106 and 108 (e.g., a modem, router, switch, gateway, wireless access point, mesh access point, extender, hub, and/or any other suitable networking equipment), devices 112 and 114. In some embodiments, modem 106, router 107 and/or networking equipment 122 may comprise a traffic analysis module 121 and/or a traffic flow identification and policy enforcement module (TIPE) module 123. In some embodiments, cloud server 124 comprises a traffic generating application 125. System 100 may comprise any suitable combination of hardware and/or software to provide the functionalities described herein.

Service provider network 102 may include, for example, any suitable software and/or hardware (e.g., networking equipment, servers, and/or databases) and/or any suitable infrastructure (e.g., physical cable transmission lines, fiber-optic transmission channels or mediums or channels, satellites) to provide core, regional, access networks and/or backhaul (and/or any other suitable portion of the network) of one or more Internet service providers (ISPs), to facilitate a telecommunications network. In some embodiments, the ISP may be provided by a business or other organization that provides access to the Internet for a fee. For example, service provider network 102 may correspond to or comprise a wide area network (WAN), to facilitate Internet connectivity (or connectivity over any other suitable public or private network) between networked devices worldwide or over any other suitable geographic region or location(s), to enable such devices to exchange information and resources. In some embodiments, a WAN or service provider network 102 may be used to connect LANs (and/or other types of communication) to enable electronic communications between remotely located devices. In the example of FIG. 1, the local area network (LAN), e.g., a small scale network for data exchange between a group of computers or other devices at a single location, provided at location 104 by way of networking equipment 106 and/or 108, may not be considered as part of the WAN provided by service provider network 102. Service provider network 102 may provide broadband, high bandwidth Internet access.

In some embodiments, networking equipment 122 and cloud server 124 may be located remote from location 104. The devices, servers, and networking equipment of system 100 may communicate over a wired connection and wireless connection. For example, devices 112, 114 and networking equipment 106 and 108 may be equipped with antennas for transmitting and receiving electromagnetic signals at frequencies within the electromagnetic spectrum, e.g., radio frequencies, to communicate with each other over a network in a localized area. The network within location 104 may correspond to, e.g., a wireless fidelity (Wi-Fi) network, such as, for example, 802.11n, 802.11ac, 802.11ax, Wi-Gig/802.11ad, 802.11 (Wi-Fi 7) at a fronthaul of a telecommunications network, to provide wireless networking technology allowing electronic devices to connect to one another and/or the Internet from a shared network access point.

The devices of system 100 may communicate over a wired LAN and/or may communicate wirelessly over a wireless LAN (WLAN) and to transmit data to and receive data from the Internet, and may be present within an effective coverage area of the localized network. The Internet is a global system of interconnected computer networks and devices employing common communication protocols, e.g., the transmission control protocol (TCP), user datagram protocol (UDP) and the Internet protocol (IP) in the TCP/IP or UDP/IP suite.

Router 108 may be configured to forward or route data packets from the Internet connection, received by way of modem 106, to devices within the localized network of system 100 and receive data packets from such devices. In some embodiments, router 108 may include a built-in modem to provide access to the Internet for the household (e.g., received by way of cable or fiber connections included in backhaul portions of a telecommunications network), built-in switches or hubs to deliver data packets to the appropriate devices within the Wi-Fi network, built-in access points to enable devices to wirelessly connect to the Wi-Fi network, and/or system 100 may include one or more stand-alone modems, switches, routers and access points. In some embodiments, modem 106 and/or router 108 may be leased from and/or installed at location 104 (e.g., the customer's premises) by the ISP as part of a managed Wi-Fi install, to give service provider network 102 visibility into LAN and WAN network traffic associated with data transmitted to or receive from modem 106 of location 104.

In some embodiments, one or more applications and/or media assets may be provided to user 110 by way of wired or wireless signals transmitted through the LAN at location 104. For example, user 110 may be playing a video game 116 (e.g., “Call of Duty”) via smart television 112 and/or a video game console, each of which may be connected to the Internet via the LAN within location 104 to provide such video game. As another example, tablet 114 may simultaneously be connected to the Internet via the LAN to provide a video conferencing application (e.g., Zoom) 118 to user 110.

In some embodiments, devices 112 and 114 may be, for example a headset; a mobile device such as, for example, a smartphone or tablet; a laptop computer; a personal computer; a desktop computer; a smart television; a smart watch or wearable device; smart glasses; extended reality (XR) head-mounted display (IMD); a stereoscopic display; a wearable camera; XR glasses; XR goggles; a near-eye display device; a robot; an autonomous cleaning device; or any other suitable user equipment or device capable of connecting to the Internet or other suitable network; or any combination thereof.

In some embodiments, traffic analysis module 121 and TIPE module 123 may be implemented in conjunction to achieve one of more of the functionalities described herein. For example, traffic analysis module 121 may compute results of network traffic analysis in the LAN and/or WAN in real-time for a subscriber home (e.g., at location 104) and/or perform a metering function with respect to preferential and/or non-preferential network traffic, and TIPE module 123 may be configured to apply a policy when a data cap is met, based on an indication received from traffic analysis module 121.

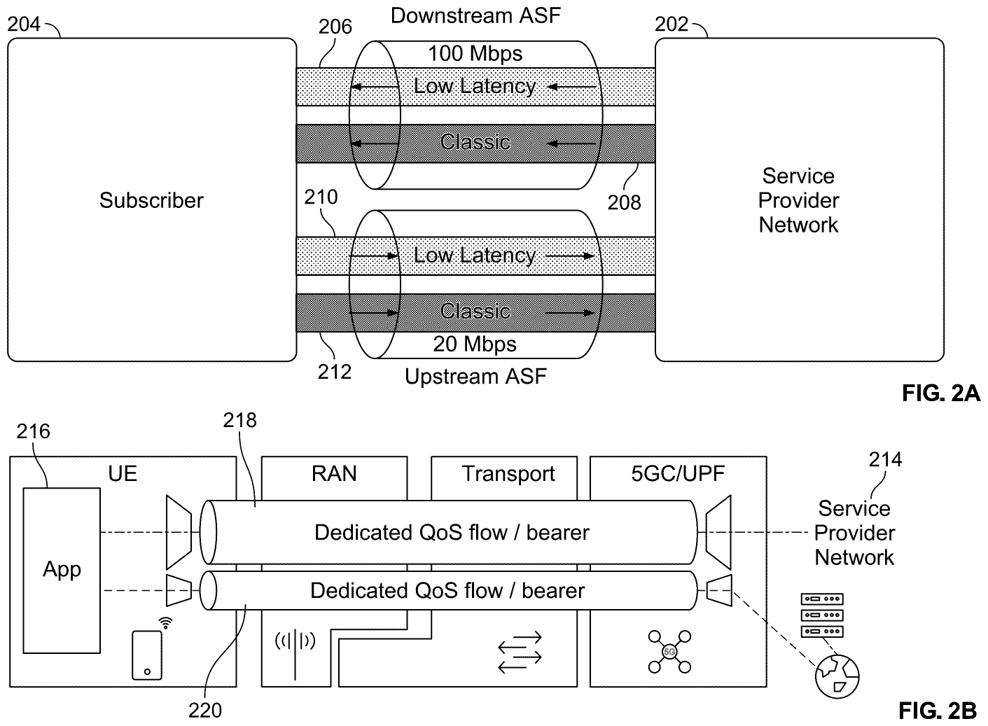

FIGS. 2A-2B show illustrative block diagrams for providing a dual queue service configuration, in accordance with some embodiments of this disclosure. System 100 may provide (e.g., in the WAN) a queue for low latency (e.g., L4S) network traffic and a queue for classic traffic, based at least in part using networking equipment 122 of FIG. 1. For example, the low latency queue of system 100 may be associated with low latency service flow 206 and low latency service flow 210, and the classic queue of system 100 may be associated with classic queue of service flow 208 and 212, as discussed in more detail in as White et al., “Low Latency DOCSIS: Technology Overview,” Cable Labs, 2019 Fall Technical Forum SCTE-ISBE (hereinafter “White et al.), the contents of which are hereby incorporated by reference herein in their entirety. A downstream aggregate service flow (ASF) over service flow 206, 210 between subscriber 204 and service provider network 202 may include low latency service flow 206 and classic service flow 210, and an upstream ASF between subscriber 204 and service provider network 202 may include low latency service flow 210 and classic service flow 212. In some embodiments, networking equipment (e.g., modem 106 and/or router 108 and/or other networking equipment) may provide one or more buffers or other suitable memory at which the low latency queue and the classic queue may be stored. In some embodiments, system 100 may employ per-flow queues and/or per-flow AQMs, in addition to or in the alternative to dual-queuing.

In some embodiments, service provider network 202 may correspond to service provider network 102 of FIG. 1, networking equipment modem 106 and/or router 108, and subscriber 204 may correspond to networking equipment 106, 108 of user 110 at location 104 of FIG. 1. FIG. 2B may correspond to an architecture for a cellular network, and service provider network 214 which may correspond to service provider network 102 of FIG. 1, and client device or user equipment 216 may correspond to service provider network 102 of FIG. 1, networking equipment 122 and/or cloud server 124.

L4S provides an end-to-end solution to provide certain traffic flows, such as, for example, gaming or voice, with reduced latency. With L4S, the data source and/or data recipient may execute congestion control algorithms to efficiently utilize available capacity while minimizing latency and packet loss, where the data source may use congestion feedback received from the recipient to optimize data transmission. With L4S, the header of an IP packet may indicate, via an explicit congestion notification (ECN), whether the IP packet supports L4S and whether congestion is being experienced, e.g., marking specific packets as having queuing delay that exceeds a threshold. L4S may be implemented at the transport layer by the service provider network and/or application service providers at client and server. In some embodiments, L4S may be enabled by operating system (OS) providers, such as, for example, Google and Apple.

As stated in RFC 9330, “The Dual-Queue Coupled AQM . . . acts like a ‘semi-permeable’ membrane that partitions latency but not bandwidth. As such, the two queues are for transitioning from Classic to L4S behaviour, not bandwidth prioritization.” RFC 9330 further states that “Two separate queues are used to isolate L4S queuing delay from the larger queue that Classic traffic needs to maintain full utilization” and “The two queues act as if they are a single pool of bandwidth in which flows of either type get roughly equal throughput without the scheduler needing to identify any flows.”

RFC 9330 further states that “the scheduler can serve the L4S queue with priority (denoted by the ‘1’ on the higher priority input), because the L4S traffic isn't offering up enough traffic to use all the priority that it is given. Therefore, for latency isolation on short timescales (sub-round-trip), the prioritization of the L4S queue protects its low latency by allowing bursts to dissipate quickly; but for bandwidth pooling on longer timescales (round-trip and longer), the Classic queue creates an equal and opposite pressure against the L4S traffic to ensure that neither has priority when it comes to bandwidth—the tension between prioritizing L4S and coupling the marking from the Classic AQM results in approximate per-flow fairness.”

As further stated in White et al., AQM can ensure that the Classic queue is not starved: “To enable the Low Latency Queue to rapidly dequeue an arrived burst of traffic, the Inter-Service-Flow scheduler gives a higher weight to the Low Latency Queue than it does to the Classic Queue. The coupling to the Low Latency AQM counterbalances the weighted scheduler by making low-latency applications leave space for Classic traffic. This ensures that the weighted scheduler does not give priority over bandwidth, as a traditional weighted scheduler would.” Further, as stated in Internet Engineering Task Force (IETF), “Dual-Queue Coupled Active Queue Management (AQM) for Low Latency, Low Loss, and Scalable Throughput (L4S),” RFC 9332, January 2023, (referred to herein as RFC 9332), the contents of which are hereby incorporated by reference herein in their entirety: “The scheduling weight of the Classic queue should be small (e.g., 1/16) . . . if L4S traffic is over-aggressive or unresponsive, the scheduler weight for Classic traffic will at least be large enough to ensure it does not starve in the short term” and “The scheduler draining the two queues MUST give L4S packets priority over Classic, although priority MUST be bounded in order not to starve Classic traffic” and “The L4S queue has latency priority within sub-round-trip timescales, but over longer periods the coupling from the Classic to the L4S AQM . . . ensures that it does not have bandwidth priority over the Classic queue.”

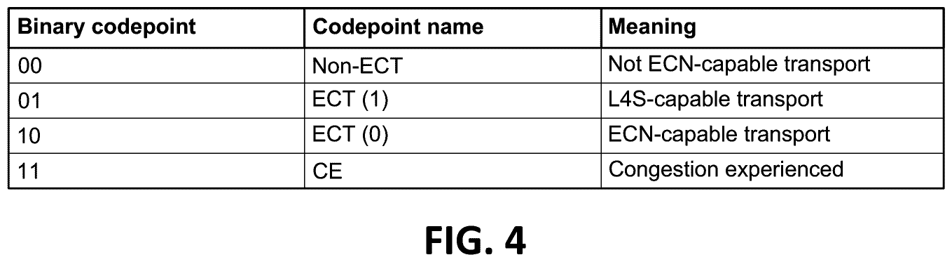

FIG. 4 shows illustrative marking of explicit congestion notification (ECN) bits, in accordance with some embodiments of this disclosure. In some embodiments, to determine whether a packet should be assigned to a low latency service flow (e.g., 206, 210, 218 of FIGS. 2A-2B), ISPs and application service providers of low latency traffic (e.g., cloud gaming) of system 100 may mark portions of their traffic with a codepoint, e.g., a differentiated services (DiffServ) codepoint or any other suitable codepoint. This codepoint indicates the ISP's and/or application service provider's ability to perform scalable congestion control, e.g., to respond to a congestion notification in a graceful manner that does not aggressively reduce throughput. For example, the ISP or application service provider may use the DiffServ field information to shift a packet to the low latency service flow in a “weakest link” of the network, such as, for example, the access network. In some embodiments, the ISP or application service provider may signal congestion using an ECN field when appropriate, to produce a graceful degradation in throughput from the application service provider's server. In some embodiments, an ISP and/or application service provider may allow a customer to indicate that network traffic to a particular device and/or for a particular application, e.g., based on a particular service type associated with the application, should be provided with latency priority, e.g., assigned to the low latency service flow.

In some embodiments, ECN may be contained within the DiffServ codepoint to indicate whether or not congestion is experienced by marking the two least-significant bits in the DiffServ in the IP header identifying a data packet. For example, the most significant six bits in the DiffServ field may contain the differentiated services code point (DSCP) bits, and the state of the two ECN bits indicates whether or not the packet is an ECN-capable packet and whether or not congestion has been experienced. A sender of network traffic may indicate a packet as ECN-capable or non-ECN-capable based on whether the sender is ECN-capable. If an ECN-capable packet experiences congestion at the egress queue of a switch, router, and/or other network component, such switch, router, and/or other network component may mark the packet as experiencing congestion. When the packet reaches the ECN-capable receiver (destination endpoint), the receiver echoes the congestion indicator to the sender (source endpoint) by sending a packet marked to indicate congestion, and after receiving the congestion indicator from the receiver, the source endpoint reduces the transmission rate to relieve the congestion,” as described in “Understanding CoS Explicit Congestion Notification,” Juniper Product and Release Support, Nov. 29, 2023, the contents of which are hereby incorporated by reference herein in their entirety.

As shown in FIG. 4, in some embodiments, two ECN bits in the DiffServ field provide four codes that determine if a packet is marked as an ECN-capable transport (ECT) packet, meaning that both endpoints of the transport protocol are ECN-capable, and if there is congestion experienced (CE). Historically, codes 01 and 10 had the same meaning, namely that the sending and receiving endpoints of the transport protocol are ECN-capable, and there was no difference between these codes. Recent work, however, earmarks ECT(1) as the bit pattern for L4S-capable traffic. System 100 may modify such interpretation of the ECN bits by assigning distinct meanings to ECT(0) and ECT(1) in order to designate at least two different traffic classes. In some embodiments, ECT(1), e.g., bit pattern 01, may be used to indicate L4S-capable traffic, and ECT(0), e.g., bit pattern 10, may be used to indicate that the sender is capable of receiving explicit congestion notification (though the sender may not be compliant with L4S). In some embodiments, L4S-capable traffic marked by an application server is assigned to ECT(1) and L4S-capable traffic marked by an ISP (e.g., based on customer preferences) is assigned to ECT(0). For example, ECT(0) is used as an internal reference for network traffic that is designated as preferential by the ISP rather than the application provider. In some embodiments, ISPs can independently choose which bit combination represents one of the two classes described above, or multiple ISPs can agree on the definition and/or choice of ECT(0) and ECT(1). In some embodiments, system 100 may add one or more extra bits to be added, specifically to indicate whether such a data packet having such bits was marked by an ISP operator or application service provider providing L4S enablement.

In some embodiments, the same bits that are used for designating whether the client-server are ECN-capable may also be used for marking whether congestion is actually experienced in the network (bits 11: CE). Thus, if a packet has the ECN bits marked as CE, then, in order to classify it as either marked by the application service provider or by the ISP (to meter the traffic accurately and apply policy), the ISP may perform a lookup of that flow identifier (ID) from a prior packet belonging to the same network traffic flow to check its traffic class, to determine whether the sender packet was marked with 10 or 01.

As described in more detail below, system 100 may be configured to enable application service providers and/or the ISP to intelligently determine whether a portion of data being transmitted or to be transmitted to a device (e.g., device 112 or 114 of FIG. 1 at particular location 104 of FIG. 1) over a network (e.g., service provider network 102) should be provided using the a first queue for preferential (e.g., L4S-capable) network traffic (e.g., via service flow 206, 210, and/or 218 of FIGS. 2A-2B) and a second queue for non-preferential (e.g., non-L4S) network traffic (e.g., via service flow 208, 212, and/or 220 of FIGS. 2A-2B). For example, system 100 may selectively employ the first queue based on a latency requirement for a portion of the data related to the user experience to be provided to the device on the LAN during a network session, and/or based on other characteristics of such portion of data. In some embodiments, network session data provided to the device on the LAN during a network session may comprise a plurality of portions of data, where certain portions may be treated preferentially (e.g., provided to the device using the first queue) during the network session, and other portions of the data may be treated non-preferentially (e.g., provided to the device using the second queue) during the network session, based on the respective characteristics of such portions. In some embodiments, a network session may be understood as a lasting connection comprising exchange of data packets between a client device and a server, e.g., implemented as a layer in a network protocol.

In some embodiments, such preferential treatment may be selectively turned on and off based on determining whether to employ L4S (or not) for the portions of the network session data. In some embodiments, system 100 may use L4S in conjunction with one or more other techniques, e.g., DiffServ, to forward packets via low latency service flow at the expense of packets over the classic service flow. In some embodiments, if a particular portion of a traffic flow is not L4S-capable, system 100 may cause an ISP and/or application service provider to be informed of the request, which may cause the ISP and/or application service provider to configure the network traffic to be L4S-capable (e.g., via an API call).

System 100 may automatically switch between using the first queue for preferential traffic, and using the second queue for non-preferential traffic, for any suitable network traffic or portions thereof, e.g., based on application determined low latency needs for a current portion of the network traffic. For example, system 100 may, for network traffic identified as cloud gaming and in-home console/personal computer (PC) streaming to remote players, selectively employ the first queue or the second queue for portions of the traffic during a network session, e.g., based on the latency needs of a game at a particular point within the game. For example, system 100 may determine that for cutscenes or a menu screen or advertisements of the video game, the second queue may be sufficient. On the other hand, for actual game play of the video game (e.g., in basketball video game, when the user (e.g., user 110 of FIG. 1) is controlling one or more of the players and is competing against an opponent, whether controlled by another user or a computer), the first queue may be employed to deliver such traffic to the client device.

As another example, system 100 may, for network traffic identified as network/cloud-based-simultaneous localization and mapping (SLAM), e.g., used in robotics, drones, self-guided vehicles, XR, and/or other applications. In some embodiments, based on proximity of the device (e.g., on the LAN) in relation to distance and speed of other objects in a surrounding environment, and/or based on the state of remote control of equipment or the type of control, system 100 may selectively determine whether to employ the first queue or the second queue.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

As another example, system 100 may, for network traffic identified as in-home or on premises security or other security (e.g., outdoor security cameras), system 100 may determine whether the first queue or the second queue should be employed, e.g., based on whether a live view is in progress, for which the first queue may be employed, upload of a clip. As another example, system 100 may, for network traffic identified as corresponding to a category of interacting with live events, determine whether to enable or disable preferential treatment based on determining whether there is an interactive opportunity with an over-the-top (OTT) live broadcast event. As another example, system 100 may, for network traffic identified as corresponding to a category of remote control of vehicles, determine whether to utilize the first queue or the second queue based at least in part on vehicle speed and/or other vehicle characteristics, and/or based on other objects proximity to the vehicle and/or speed.

In some embodiments, system 100 may make intelligent determinations of whether to treat network traffic in a preferential manner based at least in part on allowing a user to set one or more priorities for application service providers. For example, user preferences for video conferencing network traffic may indicate that network traffic corresponding to certain meetings and/or specific speakers should be treated preferentially. As another example, user preferences for cloud gaming and console game streaming may indicate that network traffic corresponding to a particular genre, specific title, and/or specific user within an account should be treated preferentially and optimized. As another example, user preferences for network traffic corresponding to in-home security may indicate that network traffic corresponding to a specific camera, people and/or activity detected and/or other type of activity, should be treated preferentially and optimized.

In some embodiments, system 100 may enable and disable L4S-marked packets a data flow based on an application determined QoE accounting for bandwidth, latency, jitter and/or other network characteristics. This may be performed for any suitable network traffic, e.g., low latency cases for cloud gaming, console-based streaming, multiplayer gaming, cloud-based SLAM for XR, robotics and autonomous vehicles, remote control of vehicles and devices, video conferencing, security/surveillance systems, betting systems, and/or any other suitable network traffic.

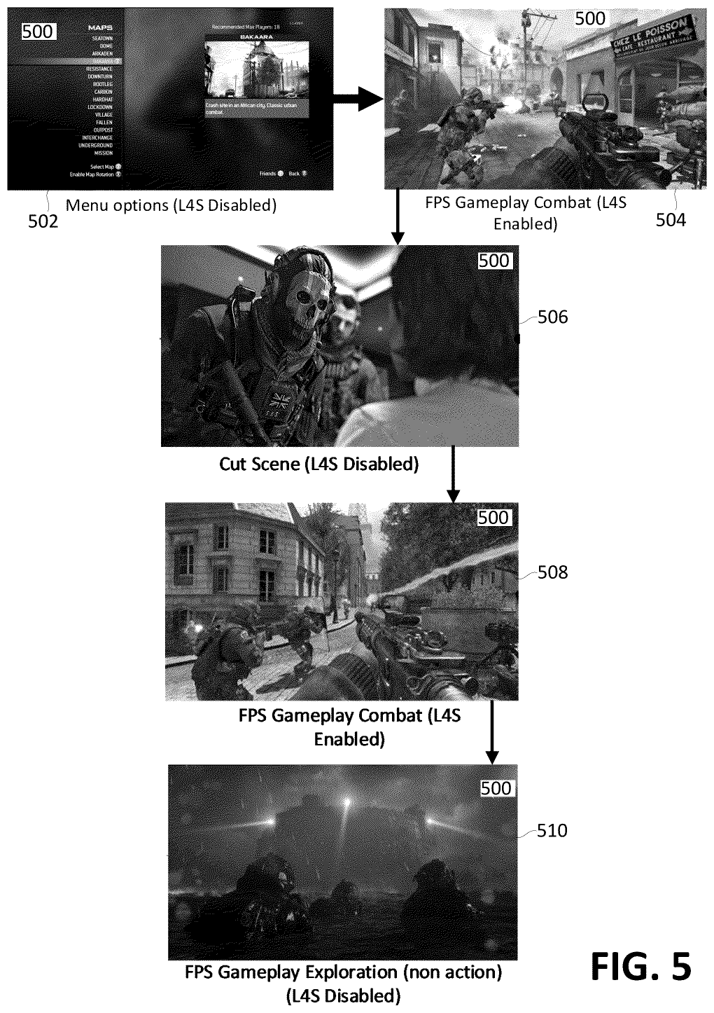

FIG. 5 shows an example of selectively treating portions of data as preferential or non-preferential during a network session, in accordance with some embodiments of this disclosure. Latency requirements in remote rendered gaming (cloud gaming), varies based on interactivity. As an example, first person shooter (FPS) games, such as video game 500, often have an extremely low latency requirement. FPS games require fast reflexes and precision targeting, and small delays in input response can significantly impact gameplay. In some embodiments, when providing an FPS video game that is remotely rendered, system 100 may use an ultra-low latency delivery system SCReAM, to enable the L4S bit in the real-time protocol (RTP) and real-time transport control protocol (RTCP) packets, and/or along with selecting an optimal edge server based on the user's location.

System 100 may determine that portion 502 of video game 500 that is being transmitted to, or that is to be transmitted to, a device (e.g., device 112 or 114 of FIG. 1) corresponds to a menu of the video game, e.g., prior to initiating the actual gameplay of the video game or when the actual gameplay is paused, or otherwise does not require a relatively higher latency. Thus, system 100 may cause portion 502 to be provided to the client device (e.g., device 112 or 114 of FIG. 1) using a non-preferential service flow. In some embodiments, when using L4S or another technique to give preferential treatment to certain portions of network traffic, system 100 (e.g., which may comprise a game engine or may be in communication with a game engine) may transmit requests through APIs to the ultra-low latency delivery system (e.g., system 100, using low latency queue 206 of FIG. 2A) on when to set the L4S bits and when not to. For example, at portion 504, which may occur after the menu portion 502 of video game 500 ends, system 100 may determine that FPS gameplay combat (or another latency-intensive portion of gameplay) is occurring against other players and/or characters controlled by the CPU, and thus system 100 may employ the first low-latency queue when providing data corresponding to portion 504 to the client device. At portion 506, which may occur at a time after portion 504 occurs within video game 500, the system may determine that portion 506 corresponds to video game 500 switching to a cutscene (e.g., a narrative scene which may be prerecorded and does not involve the user providing inputs or involves some user inputs), or during which an advertisement or other supplemental content is displayed, for which the second queue for non-preferential traffic may be determined to be sufficient to transmit such data over the network. For example, even if a cutscene allows some level of interactivity by the user (e.g. selecting a particular button on a controller at a certain time), the system may determine that such cut scene is still not latency sensitive and should be provided using the second non-preferential network traffic queue. At portion 508, which may occur at a time after portion 506 within video game 500, the system may determine that portion 508 has returned to FPS gameplay combat, and thus may enable L4S for transmission of such data or otherwise treat such data preferentially. At portion 510, which may occur at a time after portion 508 within video game 500, the system may determine that portion 510, while corresponding to actual gameplay of video game 500, may nonetheless be delivered using the second, non-preferential queue, since content of such scene corresponds to exploration of a world in video game 500 (or other relatively less latency sensitive portion), rather than combat as in portions 504 and 508, and thus L4S may be disabled. For example, data corresponding to portion 510 during the network session may be processed using the second queue for non-preferential traffic.

In some embodiments, L4S packet markings (or other preferential treatment) may be enabled during gameplay of portions of the game (e.g., determined by the game developer) such as, for example, when the player reaches a specific location within a level or during a boss fight. In some embodiments, the system and/or game engine may use pre-existing gaming metadata to determine when to signal the start of applying the L4S packet markings. In some embodiments, the metadata may be written to an XML file (or any other suitable file or data structure), and networking equipment or another suitable device may read that file and/or send or receive such file via an API. For example, a game engine may make an API call to “enable or disable” priority or preferential treatment (e.g., L4S and/or another suitable mechanism) for a particular portion of network session data.

In some embodiments, the system may perform audio and/or visual analysis in real time and/or any other suitable analysis to identify what type of scene is being played in the video game. In some embodiments, such analysis and/or metadata may indicate to the system whether a portion of the network session data is latency sensitive (or not). For example, in a cloud gaming session, combat gameplay may be considered latency sensitive, while a cutscene, or an advertisement, or levels of the game where the user is just exploring a map, for example, may not be latency-sensitive. As another example, in a football video game, plays during the game (e.g., a field goal or extra point being kicked, or a play from the line of scrimmage in which the offense of one team is competing with the defense of the opposing team) may be considered latency sensitive, but a time after the play, or a time when a coach or fans are shown in gaps between plays, may not be considered latency sensitive.

In some embodiments, whether a portion of network session data is latency sensitive (or not) may depend at least in part on a threshold latency (and/or a threshold for another network characteristic) that is required for a given portion of a video for optimal QoE, and the system may use such threshold in determining whether to employ the first queue or the second queue. In some embodiments, the threshold latency may be a single value or a range of values. In some embodiments, the system may use inputs from the users (e.g., how quickly inputs are being received currently or historically for that portion from the user and/or other users, or audio or other input received from the user) to determine what type of scene is being played, e.g., combat or exploration. FIG. 5 shows examples of gameplay modes where the system and/or game engine may automatically enable L4S (or other preferential treatment of network traffic) based on the in-game latency requirements.

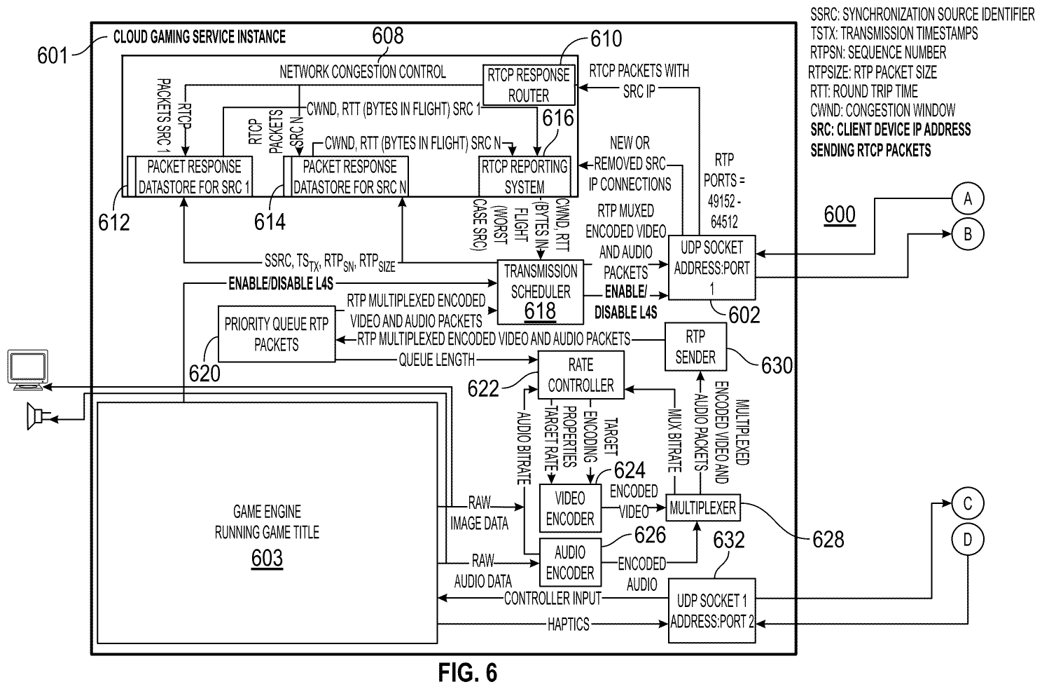

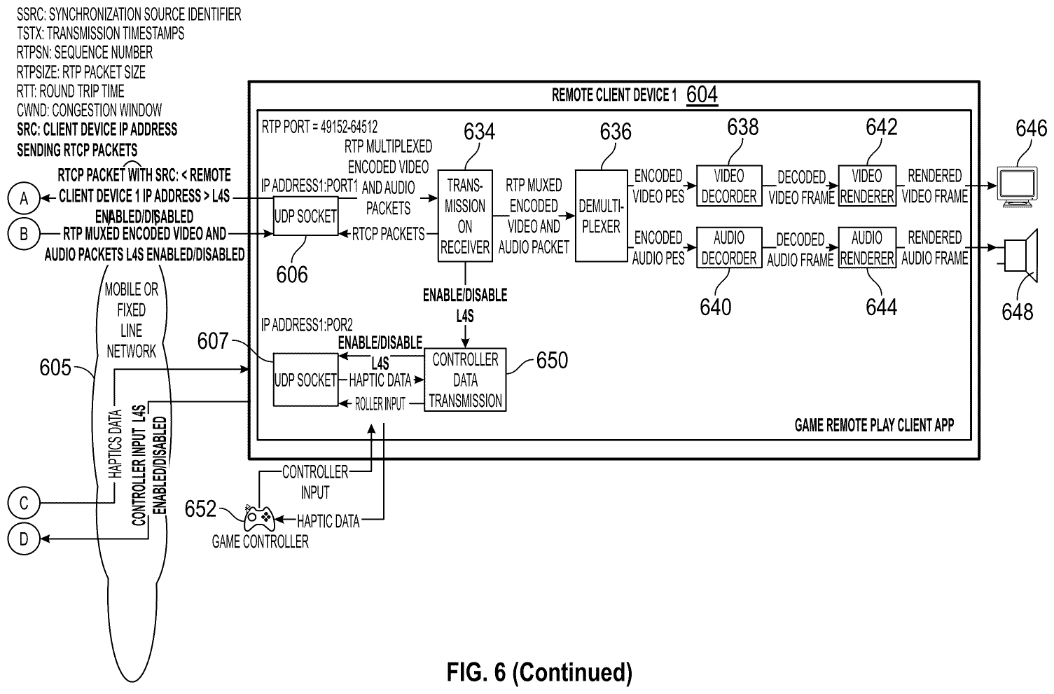

FIG. 6 shows an illustrative architecture of a system 600 for selectively treating portions of data as preferential or non-preferential during a network session, in accordance with some embodiments of this disclosure. In some embodiments, system 600 may comprise or correspond to a cloud gaming system where L4S enablement is controlled by the game engine. In some embodiments, system 600 utilizes a cloud-based architecture that uses SCReAM (RTP), or any other suitable technique, for extreme low latency video delivery from a cloud game instance to the client device, with the ability to turn L4S on or off within the same packet flow (e.g., during a network session). In some embodiments, game engine 603 may control when L4S packets are turned on or off based on the latency interaction requirements within the game. In some embodiments, system 600 may be implemented at least in part by one or more portions of system 100.

As shown in FIG. 6, UDP socket address: port 1 602 of cloud gaming service instance 601 may receive, from UDP socket 606 (IP address 1: port 1) of remote client device 604 and over network 605, RTCP packets with SRC:<remote client device 1 IP address> with L4S (or other suitable preferential treatment protocol) enabled or disabled. Such packets may have been received by UDP socket 606 from transmission receiver 634. Cloud gaming service instance 601 may implement a network congestion control module 608, which may receive, at RTCP response router 610, RTCP packets with SRC IP (e.g., a client device IP address of client device 604 having sent RTCP packets (e.g., related to gameplay of a video game provided by game engine 603). RTCP response router 610 forwards RTCP packets SRC1 to packet response datastore 612, and RTP packet SRC n to packet response datastore for SRC n 614 (e.g., from various computing devices at one or more locations). Datastore 612 provides an indication of a congestion window (CWND) and round-trip time (RTT), e.g., bytes in flight) for SRC1 to RTCP reporting system 616. Datastore 614 provides an indication of a congestion window and RTT for SRC n to RTCP reporting system 616. In some embodiments, UDP socket 602 may provide indications of new or removed SRC IP connections to network congestion control module.

RTCP reporting system 616 may receive one or more inputs. For example, RTCP reporting system 616 may transmit, to transmission scheduler 618, CWND RTT (bytes in flight) for a worst case SRC. Additionally or alternatively, transmission scheduler 618 may receive from game engine 603 an indication of whether to enable or disable L4S for a portion of network traffic (e.g., based on latency interaction requirements within the game being provided by game engine 603), and priority queue RTP packets 620 transmits RTP multiplexed encoded video and audio packets to transmission scheduler 618. Based on such inputs, transmission scheduler 618 may provide an indication to UDP socket 602 of whether to enable or disable L4S preferential treatment of a particular portion of network traffic, and UDP socket 602 may transmit, to UDP socket 606 of remote client device 604 RTP multiplexed encoded video and audio packets with L4S enabled or disabled.

Priority queue RTP packets 620 may transmit a queue length to rate controller 622. Game engine 603 may transmit raw image data for the video game being provided to the client device to video encoder 624, and may transmit raw audio data to audio encoder 626. Video encoder 624 may encode the raw image data and provide the encoded video to multiplexer 628. Audio encoder 626 may encode the raw audio data and provide the encoded audio to multiplexer 628. Multiplexer 628 may provide a multiplexed bitrate to rate controller 622, and may provide multiplexed encoded video and audio packets to RTP sender 630, which, as described above, may be provided to transmission scheduler 618 and subsequently to UDP socket 602 and client device 604. Game engine 603 may receive controller input via UDP socket 1 address: port 2 632 from UDP socket 607 (IP address 1: port 2) over network 605, and game engine 603 may transmit haptic data in relation to portions of the video game to UDP socket 632, for delivery to UDP socket 607 of client device 604 over network 605.

UDP socket 606 of client device 604 may transmit the RTP multiplexed encoded video and audio packets to transmission receiver 634, and transmission receiver 634 may transmit such packet to demultiplexer 636, which may obtain an encoded video Packetized Elementary Stream (PES) and encoded audio PES from the RTP multiplexed encode video and audio packets, and provide encoded video PES to video decoder 638 and encoded audio PES to audio decoder 640. Video decoder 638 may provide decoded video frames to video renderer 642, and audio decoder 640 may provide decoded audio frames to audio renderer 644. Video renderer 642 may cause the rendered video frames to be provided via display 646 of client device 604 to a user, and audio renderer 644 may provide rendered audio frames to audio output equipment (e.g., speaker or headphones) 648 to the user.

Controller data transmission module 650 of client device 604, e.g., provided by a game remote play client application, may be configured to receive haptic data from UDP socket 607, and transmit controller inputs received from the user (operating game controller) of client device 604 to UDP socket 607, for transmission to cloud gaming service instance 601. The haptic data may be transmitted to game controller 652, e.g., to provide vibration sensations to the user that is gaming during certain portions of the gameplay.

In some embodiments, system 600 may enable L4S (or other preferential treatment of network traffic) for the controller data transmission (transmitted based on inputs received from game controller 652) when the received packets are L4S-enabled (or enabled for other preferential treatment of network traffic) for the video/audio streams, disable disabling L4S (or other preferential treatment of network traffic) on the controller packets when L4S is not enabled (or other preferential treatment of network traffic is not enabled) on the incoming audio/video streams. For example, in cloud gaming, remote console gaming, remote vehicle control, remote control of construction equipment, and/or in other suitable applications, the controller return may be L4S enabled based on the incoming packets L4S enablement. For example, in FIG. 5, during FPS gameplay combat at portion 504 of video game 500, inputs received from the user's controlled may be processed using the first queue for preferential network traffic, to help ensure a low latency gaming experience, whereas controller inputs received when portion 502 of video game 500 is being provided to the user may be processed using the second queue for non-preferential network traffic.

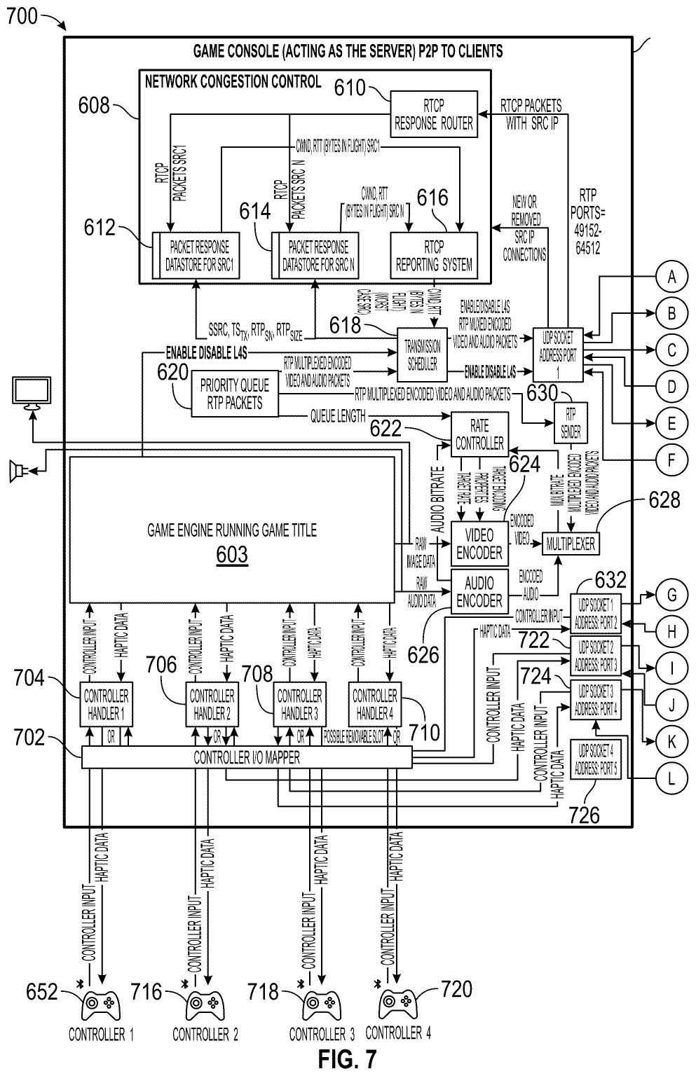

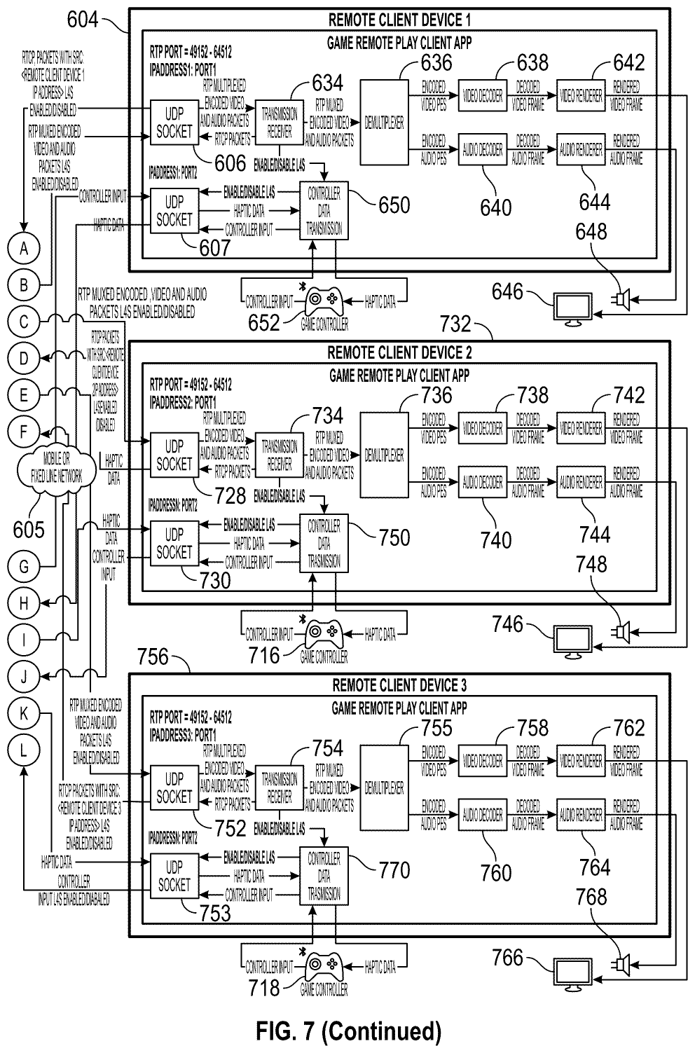

FIG. 7 shows an illustrative architecture of a system 700 for selectively treating portions of data as preferential or non-preferential during a network session, in accordance with some embodiments of this disclosure. In some embodiments, system 700 may be used for delivering data in a console-based gaming system during a multiplayer video gaming session, e.g., where the game console can support multiple remote users playing a multiplayer game running on the game console as if all players were local in the same room. Some non-limiting examples of local remote play game titles are Mortal Combat, Mario Cart and PlayStation All-Stars Battle Royale. The L4S enablement may be controlled by, e.g., a game engine of system 700. In some embodiments, system 700 uses SCReAM (RTP), or any other suitable technique, for extreme low latency video delivery from the cloud game instance to the client device, with the ability to turn L4S on or off within the same packet flow (e.g., during a network session). The game engine may be in control of when L4S packets are turned on or off based on the latency interaction requirements within the game. In some embodiments, one RTP sender and one video encoder may be used to deliver the same stream to multiple client devices. In some embodiments, if any one of such multiple client devices does not have end-to-end L4S capability, L4S may be disabled for all remote client devices. In some embodiments, system 700 may be used to transmit a separate stream may be transmitted via an adaptive bit rate (ABR) server to a one or more participants that are not in watch-only mode, as described in more detail in commonly-owned U.S. patent application Ser. No. 18/428,257 filed Jan. 31, 2024 in the name of Adeia Guides Inc., the contents of which is hereby incorporated by reference herein in its entirety.

System 700 of FIG. 7 may be implemented at least in part in a similar manner to system 600 of FIG. 6. For example, system 700 may implement game console (acting as a server) 701 (and/or which may utilize P2P communications with clients in some embodiments), and system 700 include one or more of the following portions of system 600 of FIG. 6: game engine 603, client device 604, UDP socket 607, network congestion control module 608, RTCP response router 610, packet response datastore for SRC1 612, packet response datastore for SRC n 614, RTCP reporting system 616, transmission scheduler 618, priority queue RTP packets 620, rate controller 622, video encoder 624, audio encoder 626, multiplexer 628, RTP sender 630, UPD socket 1 632, transmission receiver 634, demultiplexer 636, video decoder 638, audio decoder 640, video renderer 642, audio renderer 644, display 646, and audio output equipment (e.g., speaker or headphones) 648.

System 700 may include controller I/O mapper 702, which may interface with controller handler 704 corresponding to controller 652; controller handler 706 corresponding to controller 716; controller handler 708 corresponding to controller 718; and controller handler 710 corresponding to controller 720. For example, controller I/O mapper 702 may receive controller input from controller 652 being operated by a first user and transmit such controller input to controller handler 704, which in turn transmits such input to game engine 703, and controller I/O mapper 702 may transmit haptic data (received from controller handler 704) to controller 652. Controller I/O mapper 702 may receive controller input from controller 716 being operated by a second user and transmit such controller input to controller handler 706, which in turn transmits such input to game engine 703, and controller I/O mapper 702 may transmit haptic data (received from controller handler 706) to controller 716. Controller I/O mapper 702 may receive controller input from controller 718 being operated by a third user and transmit such controller input to controller handler 708, which in turn transmits such input to game engine 703, and controller I/O mapper 702 may transmit haptic data (received from controller handler 708) to controller 718. Controller I/O mapper 702 may receive controller input from controller 720 being operated by a fourth user and transmit such controller input to controller handler 710, which in turn transmits such input to game engine 703, and controller I/O mapper 702 may transmit haptic data (received from controller handler 710) to controller 720. In some embodiments, the first, second, third, and fourth users, operating the controllers 652, 716, 718, and 720, respectively, may be located in different geographic areas (or the same geographic area), and may be playing the video game provided by game engine 603 over a network (e.g., network 605). In some embodiments, UDP socket 632, UDP socket 722, UDP socket 724, and UDP socket 726 may be used to receive haptic data for, and transmit controller input received from, controllers 652, 716, 718, and 720, respectively.

As shown in FIG. 7, game console 701 may receive, from UDP socket 606 (IP address 1: port 1) of remote client device 604 and over network 605, RTCP packets with SRC:<remote client device 1 IP address> with L4S (or other suitable preferential treatment protocol) enabled or disabled. Such packets may have been received by UDP socket 606 from transmission receiver 634. Game engine 603 may receive controller input via UDP socket 1 address: port 2 632 from UDP socket 607 (IP address 1: port 2) over network 605, and game engine 603 may transmit haptic data in relation to portions of the video game to UDP socket 632, for delivery to UDP socket 607 of client device 604 over network 605.

Similarly, UDP socket 728 (IP address 2: port 1) of remote client device 2 (remote client device 732) may receive RTP multiplexed encoded video and audio packets with L4S (or other suitable preferential treatment protocol) enabled or disabled. Game engine 603 may receive controller input via UDP socket 2 address: port 3 722 from UDP socket 730 (IP address n: port 2) over network 605, and game engine 603 may transmit haptic data in relation to portions of the video game to UDP socket 722, for delivery to UDP socket 730 of client device 732 over network 605.

Similarly, UDP socket 752 (IP address 3: port 2) of remote client device 3 (remote client device 756) may receive RTP multiplexed encoded video and audio packets with L4S (or other suitable preferential treatment protocol) enabled or disabled. Game engine 603 may receive controller input via UDP socket 2 address: port 4 724 from UDP socket 753 (IP address n: port 2) over network 605, and game engine 603 may transmit haptic data in relation to portions of the video game to UDP socket 724, for delivery to UDP socket 753 of client device 756 over network 605.

UDP socket 728 of client device 732 may transmit the RTP multiplexed encoded video and audio packets to transmission receiver 734, and transmission receiver 734 may transmit such packet to demultiplexer 736, which may obtain an encoded video PES and encoded audio PES from the RTP multiplexed encode video and audio packets, and provide encoded video PES to video decoder 738 and encoded audio PES to audio decoder 740. Video decoder 738 may provide decoded video frames to video renderer 742, and audio decoder 740 may provide decoded audio frames to audio renderer 744. Video renderer 742 may cause the rendered video frames to be provided via display 746 of client device 732 to the second user, and audio renderer 744 may provide rendered audio frames to audio output equipment (e.g., speaker or headphones) 748 to the second user.

Controller data transmission module 750 of client device 732, e.g., provided by a game remote play client application, may be configured to receive haptic data from UDP socket 730, and transmit controller inputs received from the user (operating game controller) of client device 732 to UDP socket 730, for transmission to game console 701. The haptic data may be transmitted to game controller 716, e.g., to provide vibration sensations to the user that is gaming during certain portions of the gameplay.

UDP socket 752 of client device 756 may transmit the RTP multiplexed encoded video and audio packets to transmission receiver 754, and transmission receiver 754 may transmit such packet to demultiplexer 755, which may obtain an encoded video PES and encoded audio PES from the RTP multiplexed encode video and audio packets, and provide encoded video PES to video decoder 758 and encoded audio PES to audio decoder 760. Video decoder 758 may provide decoded video frames to video renderer 762, and audio decoder 764 may provide decoded audio frames to audio renderer 764. Video renderer 762 may cause the rendered video frames to be provided via display 766 of client device 756 to a third user, and audio renderer 764 may provide rendered audio frames to audio output equipment (e.g., speaker or headphones) 768 to the user.

Controller data transmission module 770 of client device 756, e.g., provided by a game remote play client application, may be configured to receive haptic data from UDP socket 753, and transmit controller inputs received from the user (operating game controller) of client device 756 to UDP socket 753, for transmission to game console 701. The haptic data may be transmitted to game controller 718, e.g., to provide vibration sensations to the fourth user that is gaming during certain portions of the gameplay. While not shown, a remote client device similar to client devices 604, 732, and 756 may be employed in relation to the fourth user operating controller 720. In some embodiments, L4S (or another suitable preferential treatment technique) may be enabled for network data corresponding to controller inputs received from controller 718, based on incoming RTP audio/video network packets being L4S enabled (or another suitable preferential treatment technique), and L4S (or disabled for another suitable preferential treatment technique) may be disabled for network data corresponding to controller inputs received from the user, based on incoming RTP audio/video network packets being L4S disabled (or disabled for another suitable preferential treatment technique).

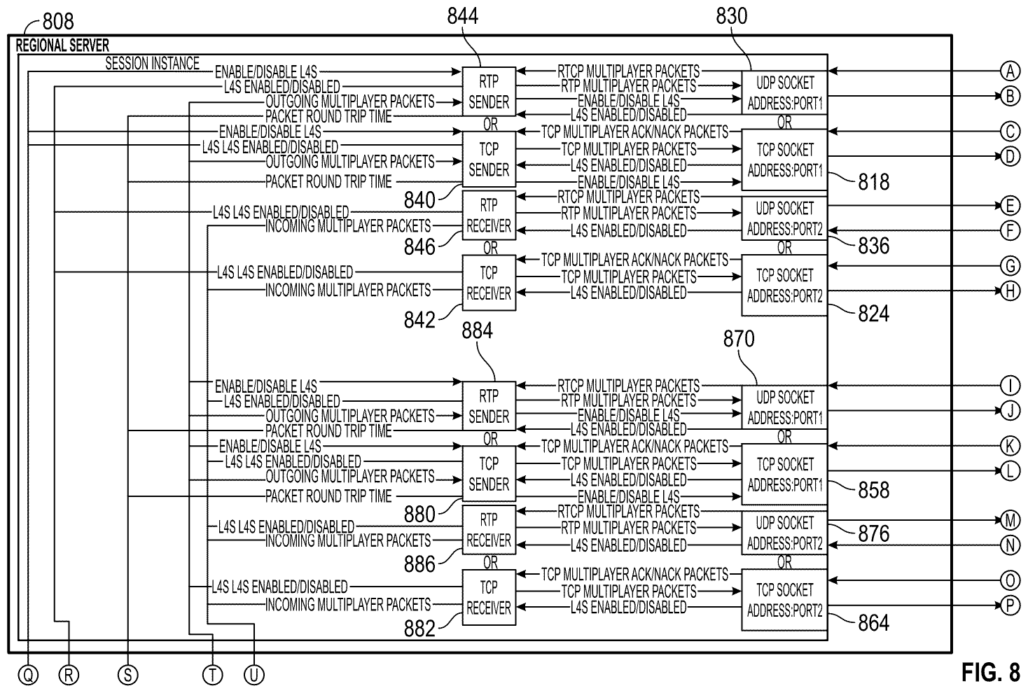

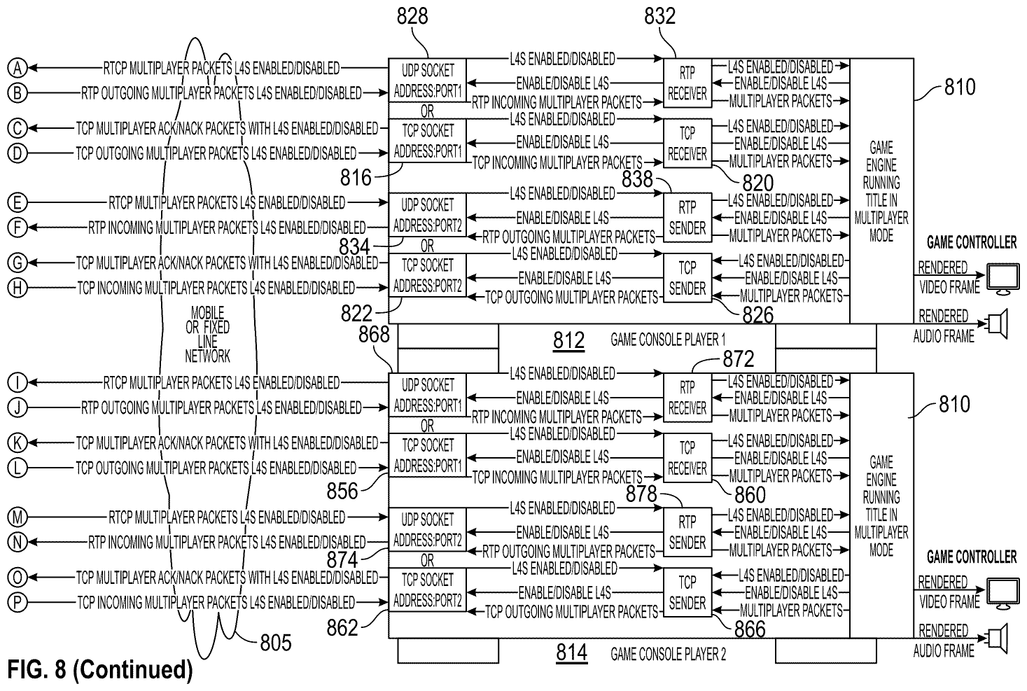

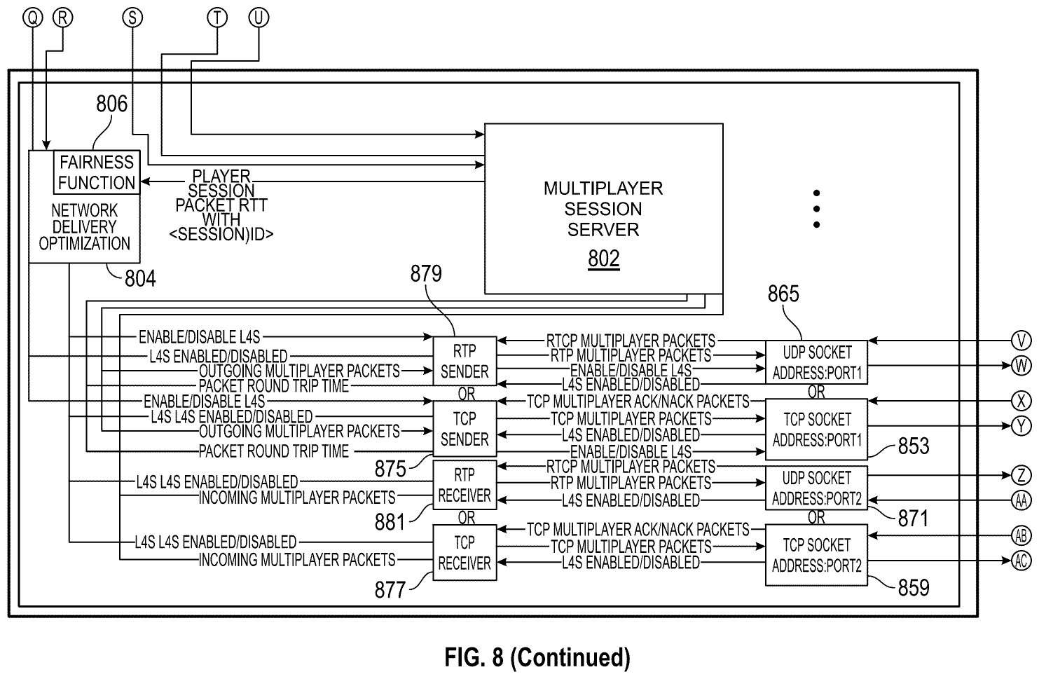

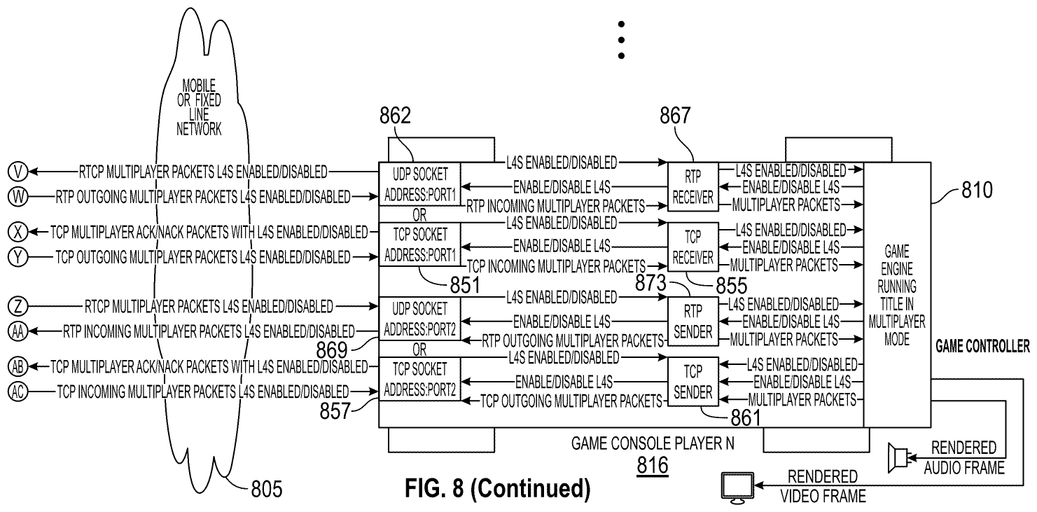

FIG. 8 shows an illustrative architecture for a system 800 for selectively transmitting data using a preferential queue or a non-preferential queue, during a multiplayer session for multiplayer gaming, in accordance with some embodiments of this disclosure. System 800 may provide a multiplayer session server 802 for multiplayer gaming with a network delivery optimization server 804, which may implement a fairness function 806. The multiplayer gaming session may be provided by one or more of multiplayer session server 802, network delivery optimization server 806, and regional server 808 over network 805 to any suitable number of devices, e.g., game console player 812 at a first client device, game console player 814 at a second client device . . . game console n 816 at n client device(s). Multiplayer session server 802 may establish a player session packet RTT with a <(session)ID> network delivery optimization server 804.

In a multiplayer locally rendered gaming session, all participants might not have L4S support along the entire route from the multiplayer server to the game device. To maintain fairness, if any player in a multiplayer gaming session does not have end-to-end L4S support, the multiplayer server may disable all L4S packet markings for all players in that multiplayer gaming session. This may be done by system 800 examining a first response packet received from each client device. For example, in the case of TCP, such response packet may be an acknowledgment/negative acknowledgment (ACK/NACK) response packet. For example, TCP socket address:port1 816 of game console 812 may transmit TCP multiplayer ACK/NACK packets with L4S enabled or disabled to TCP socket address: port1 818 of regional server 808, based on an indication received from TCP receiver 820 of game console 812, which in turn may be based on an indication received from game engine 810 (e.g., based on latency requirements for a current portion of the video game being played). TCP socket 818 may transmit, to TCP sender 840, the TCP multiplayer ACK/NACK packets and an indication of whether L4S is enabled or disabled for a particular portion of network traffic, and based on such received data, TCP sender 840 may transmit an indication of whether L4S is enabled or disabled, and the indication of a packet RTT, to network delivery optimization server 804 and/or multiplayer session server 802.

As another example, TCP socket address: port 2 822 of game console 812 may transmit TCP multiplayer ACK/NACK packets with L4S enabled or disabled to TCP socket address: port1 824 of regional server 808, based on an indication received from TCP sender 826 of game console 812, which in turn may be based on an indication received from game engine 810 (e.g., based on latency requirements for a current portion of the video game being played). TCP socket 824 may transmit, to TCP receiver 842, the TCP multiplayer ACK/NACK packets and an indication of whether L4S is enabled or disabled for a particular portion of network traffic, and based on such received data, TCP receiver 842 may transmit an indication of whether L4S is enabled or disabled, and the incoming multiplayer packets, to network delivery optimization server 804 and/or multiplayer session server 802.

In another example, in RTP, such response packet that is examined may be an RTCP packet. For example, UDP socket address:port1 828 of game console 812 may transmit RTCP multiplayer packets with L4S enabled or disabled to UDP socket address: port1 830 of regional server 808, based on an indication received from RTP receiver 832 of game console 812, which in turn may be based on an indication received from game engine 810 (e.g., based on latency requirements for a current portion of the video game being played). UDP socket 830 may transmit, to RTP sender 844, the RTCP multiplayer packets and an indication of whether L4S is enabled or disabled for a particular portion of network traffic, and based on such received data, RTP sender 844 may transmit an indication of whether L4S is enabled or disabled, and the indication of a packet RTT, to network delivery optimization server 804 and/or multiplayer session server 802.

As another example, UDP socket address:port2 834 of game console 812 may transmit RTP incoming multiplayer packets with L4S enabled or disabled to UDP socket address: port2 836 of regional server 808, based on an indication received from RTP sender 838 of game console 812, which in turn may be based on an indication received from game engine 810 (e.g., based on latency requirements for a current portion of the video game being played). UDP socket 836 may transmit, to RTP receiver 846, the RTCP multiplayer packets (and an indication of whether L4S is enabled or disabled for a particular portion of network traffic, and based on such received data, RTP receiver 846 may transmit an indication of whether L4S is enabled or disabled, and incoming multiplayer packets, to network delivery optimization server 804 and/or multiplayer session server 802.

In some embodiments, if the first response packet is not L4S marked, all L4S markings may be disabled for all players in the multiplayer gaming session. In some embodiments, a packet indicating whether L4S is supported and/or enabled may be transmitted at an initial handshake stage, e.g., when a first request is sent, the system may determine whether L4S should not be utilized for the current network session.

As shown in FIG. 8, the architecture of system 800 may provide for a multiplayer regional server 808 which includes a multiplayer session instance of a multiplayer session. The multiplayer session is served by multiplayer session server 802. Such server 802 may perform matchmaking, authentication and/or other multiplayer functions to establish and facilitate the multiplayer session instance. System 800 may optimize delivery of multiplayer session data, and may include a network delivery optimization subsystem which implements the fairness function 806. In some embodiments, each multiplayer session on both the server and the client device includes both an RTP sender and receiver or a TCP sender and receiver. On the server, the RTP sender or the TCP sender transmits the multiplayer merged game data to a client device's game engine. On the client device, the RTP or TCP sender sends the player's game play data and input to the multiplayer server. Based on the calculated TCP or RTP packet round-trip times (RTTs), system 800 may calculate both jitter and latency associated with network traffic for a device, and certain sessions may be L4S-enabled or L4S-disabled to enable fairness across sessions of the multiplayer session.

For example, multiplayer session server 802 and/or network delivery optimization server 804 may transmit indications to RTP sender 844 and TCP sender 840 of whether certain network traffic should be treated preferentially, and such indication may be propagated to the client device and game engine. For example, outgoing multiplayer packets and an indication regarding whether L4S is enabled or disabled for such packets may be forwarded to RTP sender 844 from multiplayer session server 802 and/or network delivery optimization server 804, and RTP sender 844 may transmit, to UDP socket address 830, RTP multiplayer packets and the indication regarding whether L4S is enabled or disabled for such packets. UDP socket address 830 may transmit, to UDP socket address 828, RTP outgoing multiplayer packets associated with L4S being enabled or disabled, and UDP socket address 828 may transmit the RTP incoming multiplayer packets, and the indication regarding whether L4S is enabled or disabled for such packets, to RTP receiver 832, which in turn may be transmitted to game engine 810.

For game console player 2 814 participating in the multiplayer session, TCP socket address 856, TCP socket address 862, UDP socket address 868, UDP socket address 874, TCP receiver 860, TCP sender 866, RTP receiver 872, and RTP sender 878 may be implemented in a similar manner as TCP socket address 816, TCP socket address 822, UDP socket address 834, UDP socket address 834, TCP receiver 820, TCP sender 826, RTP receiver 832, and RTP sender 838, respectively. TCP socket address 858, TCP socket address 864, UDP socket address 870, UDP socket 876, TCP sender 880, TCP receiver 882, RTP sender 884, and RTP receiver 886 of regional server 808 may be implemented in a similar manner as TCP socket address 818, TCP socket address 824, UDP socket address 830, UDP socket 836, TCP sender 840, TCP receiver 842, RTP sender 844, and RTP receiver 846 of regional server 808.

Similarly, for game console player n 816 participating in the multiplayer session, TCP socket address 851, TCP socket address 857, UDP socket address 863, UDP socket address 869, TCP receiver 855, TCP sender 861, RTP receiver 867, and RTP sender 873 may be implemented in a similar manner as TCP socket address 816, TCP socket address 822, UDP socket address 834, UDP socket address 834, TCP receiver 820, TCP sender 826, RTP receiver 832, and RTP sender 838, respectively. TCP socket address 853, TCP socket address 859, UDP socket address 865, UDP socket 871, TCP sender 875, TCP receiver 877, RTP sender 879, and RTP receiver 881 of regional server 808 may be implemented in a similar manner as TCP socket address 818, TCP socket address 824, UDP socket address 830, UDP socket 836, TCP sender 840, TCP receiver 842, RTP sender 844, and RTP receiver 846 of regional server 808.

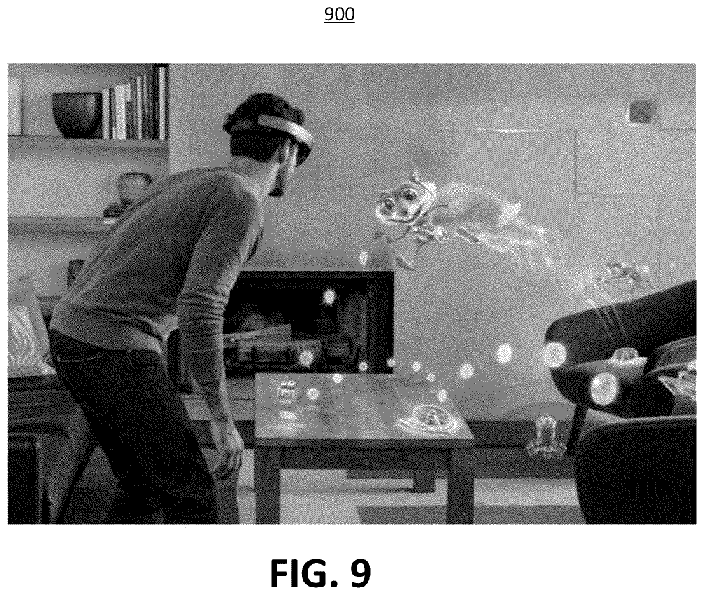

FIG. 9 is an illustrative example 900 of using SLAM on an XR head-mounted device (HMD) or headset (e.g., indoors or outdoors), enabling virtual objects to interact at close range with the physical world, to facilitate relatively more precise localization, in accordance with some embodiments of this disclosure. In some embodiments, in example 900 of FIG. 9, the system may enable L4S (or other preferential treatment of network traffic mechanism), optionally along with one or more of higher framerate, resolution video and higher bandwidth for transmitting the inertial measurement unit (IMU) and video data from the XR device to the cloud. The cloud-based SLAM system may additionally or alternatively enable L4S for the packets transmitting the localization from the cloud to the XR device. As shown in FIG. 9, the system may used SLAM in AR for rendering virtual object interacting with objects at a relatively close distance (e.g., in a particular type of location, such as a home or otherwise indoors, and/or within a threshold distance). In some embodiments, in example 900, the XR device may be rendering virtual objects in close proximity to real world objects, and may take into account the distance of the user wearing or using the XR device and the virtual objects being rendered, to determine whether a portion of network session data is latency sensitive. For example, if multiple objects are relatively close to the XR device within an XR environment, the system may consider the associated network session data to be latency sensitive, and process it using the first queue for preferential network traffic.

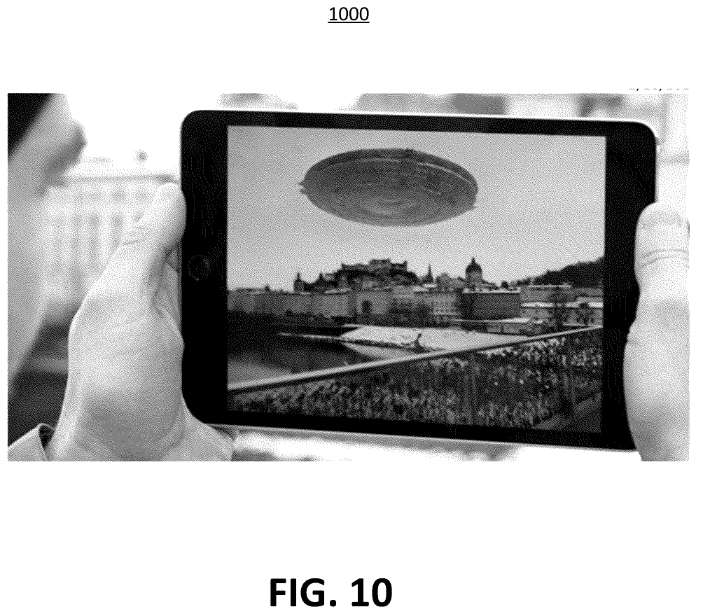

As described in more detail in commonly-owned U.S. application Ser. No. 18/128,934, filed Mar. 30, 2023 in the name of Adeia Guides Inc., the contents of which is hereby incorporated by reference herein in its entirety, the system may implement distributed SLAM delivery optimization for localization, e.g., when a spatial map already exists for a particular location. Localization and mapping may be performed within the network, and the device may transmit camera and IMU sensor data, and the network edge may perform map building and localization. In some embodiments, the images captured by the camera may be encoded using a codec, such as, for example, H.264, high efficiency video coding (HEVC), versatile video coding (VVC) or any other suitable codec, and multiplexed with IMU sensor data and transmitted to the SLAM system running at the network edge. Both the bitrate and resolution of the encoding directly effects the accuracy of the localization. Depending on the level of accuracy needed for a particular portion of network traffic being transmitted or to be transmitted, the encoded bitrate and/or resolution may be raised or lowered. When a device is far away from any object, a much lower bitrate can be used. As moving objects move into a closer range of the device or the device moves into a closer of the objects, the bitrate can be raised offering a better localization accuracy. This bitrate may be dynamically adjusted based on the changing proximity of the objects to the device. As can be seen in comparing FIGS. 9 and 10, a higher level of localization accuracy may be desirable in FIG. 9 than in FIG. 10.

FIG. 10 is an example 1000 of using SLAM on a device (e.g., indoors or outdoors) to enable a virtual object to interact at a large distance with the physical world, to facilitate relatively less precise localization, in accordance with some embodiments of this disclosure. For example, at the sender device (e.g., an XR device such as, for example, a tablet), L4S may be disabled, optionally along with a relatively lower framerate, resolution video and lower bandwidth for transmitting the IMU and video data from the XR device to the cloud. In some embodiments, the cloud-based SLAM system additionally or alternatively disable L4S for the packets transmitting the localization from the cloud to the XR device. For example, the example of FIG. 10 may be used for rendering virtual objects interacting with objects at a relatively far distance. In some embodiments, in example 1000, the XR device may be rendering virtual objects in close proximity to real world objects, and may take into account the distance of the user wearing or using the XR device and the virtual objects being rendered, to determine whether a portion of network session data is latency sensitive. For example, if no objects are relatively close to the XR device and/or objects are detected at beyond a threshold distance within an XR environment in relation to the user wearing or using the XR device, the system may consider the associated network session data not to be latency sensitive, and process it using the second queue for non-preferential network traffic.

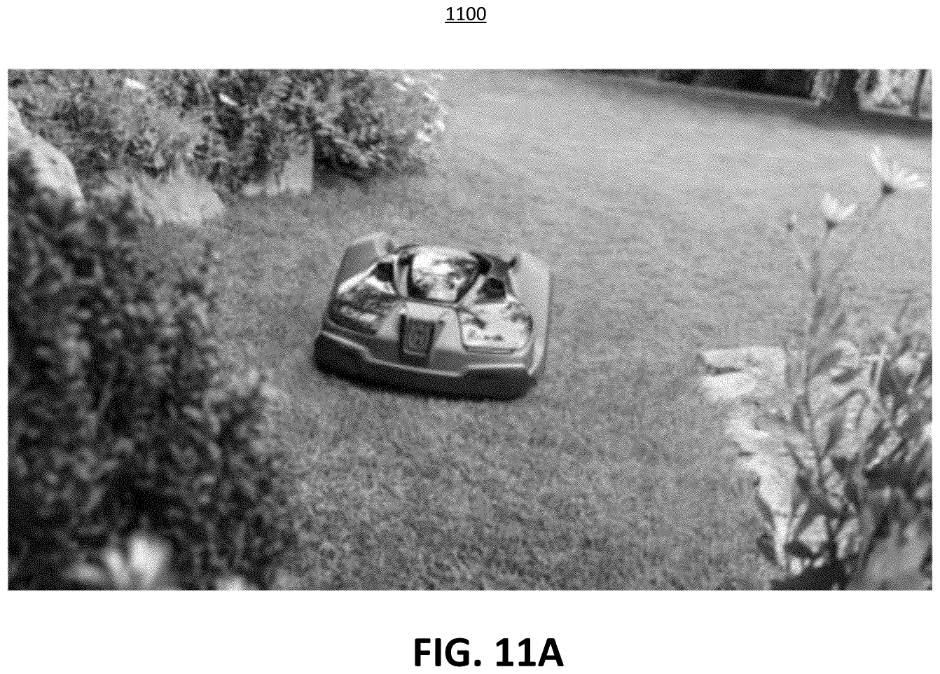

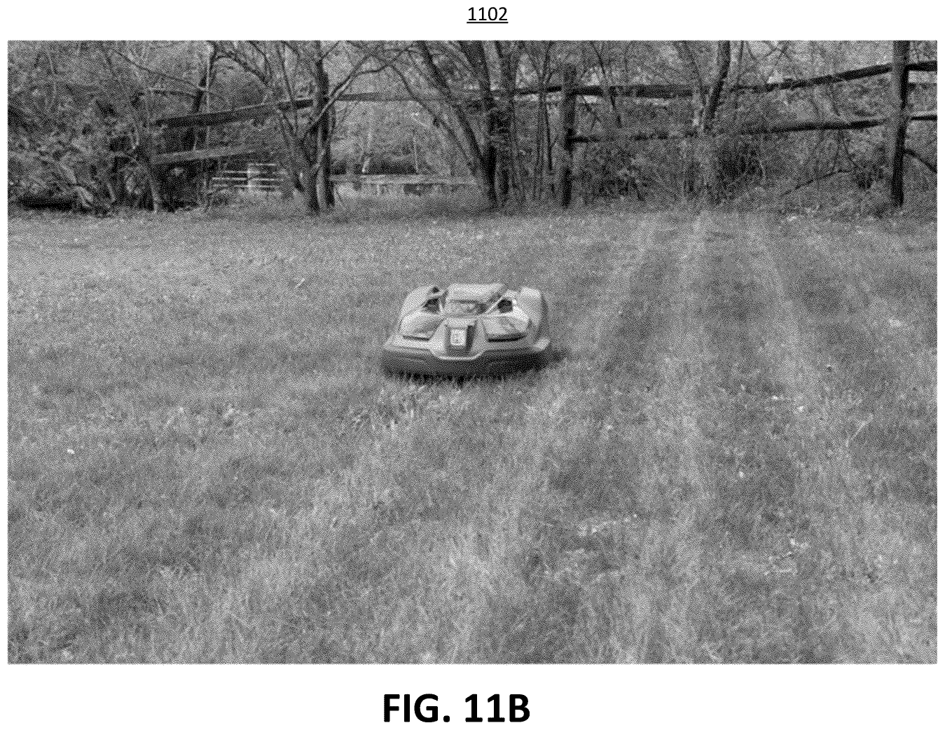

FIG. 11A is an example 1100 of using SLAM to transmit network traffic associated with a robotic lawn mower when there are physical objects (e.g., bushes, stones, flowers) close to the robotic lawn mower, requiring the localization to be more precise and frequent, in accordance with some embodiments for this disclosure. For example, L4S may be enabled at the sender (the robotic lawn mower), optionally along with a relatively higher framerate, resolution video and higher bandwidth for transmitting the IMU and video data from the mower to the cloud. The cloud-based SLAM system may additionally or alternatively enable L4S for the packets transmitting the localization from the cloud to the mower.

FIG. 11B is an example 1102 of using SLAM to transmit network traffic associated with a robotic lawn mower when there are no physical objects, or minimal physical objects, close to the robotic lawn mower, allowing the localization to be less precise and/or frequent, in accordance with some embodiments for this disclosure. For example, L4S may be disabled at the sender (lawnmower) optionally along with lower framerate, resolution video and lower bandwidth for transmitting the IMU and video data from the mower to the cloud. The cloud-based SLAM system may additionally or alternatively disable L4S for the packets transmitting the localization from the cloud to the mower.

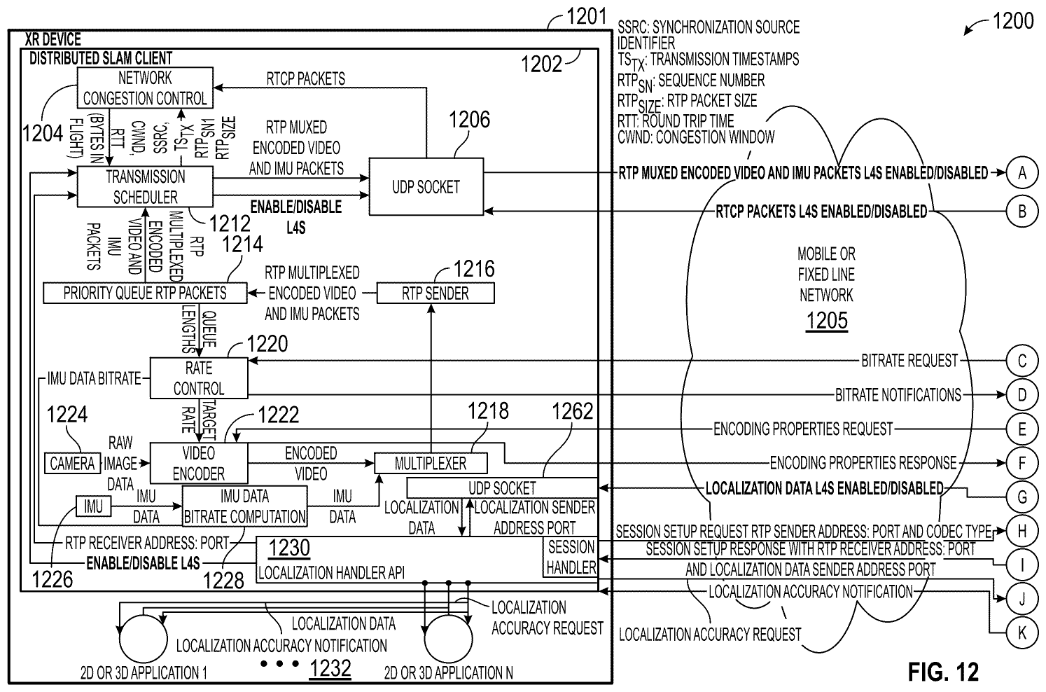

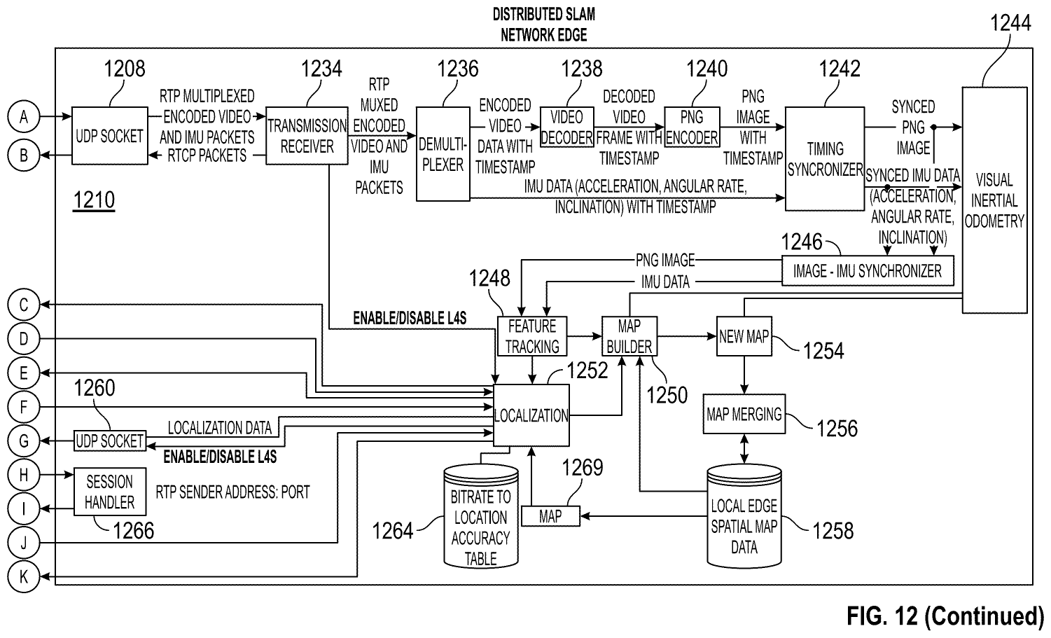

FIG. 12 is an illustrative architecture for a system 1200 having interfaces with SLAM functionalities and/or sub-functionalities, for enabling L4S in a XR device 1201 using cloud-based SLAM, in accordance with some embodiments for this disclosure. In some embodiments, system 1200 may be a SLAM system for enabling L4S packet markings based on speed, object tracking, and proximity of obstacles to an XR device or a vehicle or other device. The SLAM architecture is an expansion on MapLab which has been converted to run in the cloud with optimization for video encoding resolution and framerate based on bandwidth, localization requirements and object tracking. As discussed in relation to FIGS. 8-9, for an XR device (e.g., connected to an LAN at location 104), a lower localization precision may be sufficient, or a higher localization precision may be required, based on a speed of the XR device and/or other objects and a proximity to other objects. In some embodiments, L4S packets for the video and IMU data may be enabled on the video and IMU uplink flow and and/or may be enabled for localization within the mapped space on the downlink flow based on the localization update frequency requirements and the precision and/or accuracy of the localization. System 1200 may be utilized for robotics control and/or any other suitable application, e.g., system 1200 may be leveraged in autonomous driving, based on proximity of other moving or stationary objects around the vehicle and/or speed of the vehicle.

As shown in FIG. 12, XR device 1201 may comprise distributed SLAM client 1202. XR device 1201 may comprise network congestion control 1204 may receive, from UDP socket 1206 over network 1205, RTCP packets, which may be received from UDP socket 1208 of distributed SLAM network edge server 1210. UDP socket 1206 may receive, from UDP socket 1208 over network 1205, an indication of whether RTCP packets are enabled or disabled for L4S (or other suitable protocol to treat portions of network traffic preferentially). Transmission scheduler 1212 of XR device 1201 may transmit, to UDP socket 1206, RTP multiplexed encoded video and IMU packets and an indication of whether L4S (or another protocol to treat the packets preferentially) is enabled for such packets. Network congestion control module 1204 may transmit, to transmission scheduler 1212, CWND, RTT (bytes in flight), and network congestion control module 1204 may receive, from transmission scheduler 1212, synchronization source identifier (SSRC), transmission timestamps (TS_{TX}) of RTP packets, RTPS_{N} (sequence number) of RTP packets, and RTP_{size} (RTP packet size).

The RTP multiplexed encoded video and IMU packets may be received by transmission scheduler 1212 from priority queue for RTP packets 1214, and priority queue 1214 may have received such data from RTP sender 1216, which in turn may have received such data from multiplexer 1218. Priority queue 1214 may provide, to rate control module 1220, queue lengths, and rate control module 1220 may provide a target rate to video encoder 1222. Video encoder 1222 may receive raw image data from camera 1224, and may encode such data to obtain encoded video data to be provided to multiplexer 1218. IMU 1226 may provide IMU data to IMU data bitrate computation module 1228, which may provide the IMU data to multiplexer 1218, and which may compute and provide to rate control module 1220 the IMU data bitrate. Session handler 1230 may comprise localization handler API, and may transmit data indicating an RTP receiver address: port, and data indicating whether data packets are to be L4S-enabled or disabled, to transmission scheduler 1212. Session handler 1230 may provide one or more notifications (e.g., localization accuracy notifications), localization accuracy requests, and/or localization data to one or more 2D or 3D applications.

UDP socket 1208 may transmit RTP multiplexed encoded video and IMU packets to transmission receiver 1234 of distributed SLAM network edge server 1210, and transmission receiver 1234 may transmit RTCP packets to UDP socket 1208. Transmission receiver 1234 may transmit, to demultiplexer 1236, RTP multiplexed encoded video and IMU packets, and demultiplexer 1236 may perform demultiplexing of such data to obtain encoded video data with timestamp(s) and IMU data (e.g., acceleration, angular rate, inclination) with timestamp(s), and provide such data to timing synchronizer 1242. Video decoder 1238 may decode the encoded video data with timestamp(s) to obtain decoded video frame(s) with timestamp(s), and PNG encoder 1240 may be used to obtain PNG image with timestamp(s), to be provided to timing synchronizer 1242. Timing synchronizer 1242 may provide a synchronized PNG image, and synchronized IMU data, to visual inertial odometry module 1244 and image-IMU synchronizer 1246.

Feature tracking module 1248 may receive the PNG image and IMU data, and such data may be provided to map builder 1250 and localization module 1252, based on which map builder 1250 may generate a new map 1254 (e.g., of an environment surrounding a user of XR device 1201), and such map may be merged at 1256 (e.g., with previously generated maps at the same location and/or recently generated) and stored at local edge spatial map data datastore 1258. Localization module 1252 may transmit a bitrate request to rate control module 1220 and may transmit an encoding properties request to video encoder 1222, and receive, from transmission receiver 1234, an indication of whether to enable or disable L4S for a particular portion of network traffic; a bitrate notification from rate control module 1220 based on the transmitted bit rate request; an encoding properties response from video encoder 1222 based on the transmitted encoding properties request. Localization module 1252 may store, based on the received bitrate notification, data in the bitrate to location accuracy table 1264. Localization module 1252 may transmit localization data, and an indication of whether to enable or disable L4S, to UDP socket 1260, and UDP socket 1260 may transmit localization data, and an indication of whether L4S is enabled or disabled for the particular portion of network traffic, to UDP socket 1262 of XR device 1201. UDP socket 1262 may transmit localization data to session handler 1230, and may receive localization sender address port data from session handler 1230. Localization module 1252 may receive map data 1269 from datastore 1258.

Session handler 1266 may receive, from session handler 1230, data related to session setup request RTP sender address:port and codec type, and session handler 1266 may transmit, to session handler 1230, a session setup response with RTP receiver address:port and localization data sender address port. Localization module 1252 may receive a localization accuracy request to session handler 1230, and transmit a localization accuracy notification to session handler 1230 based on the request.

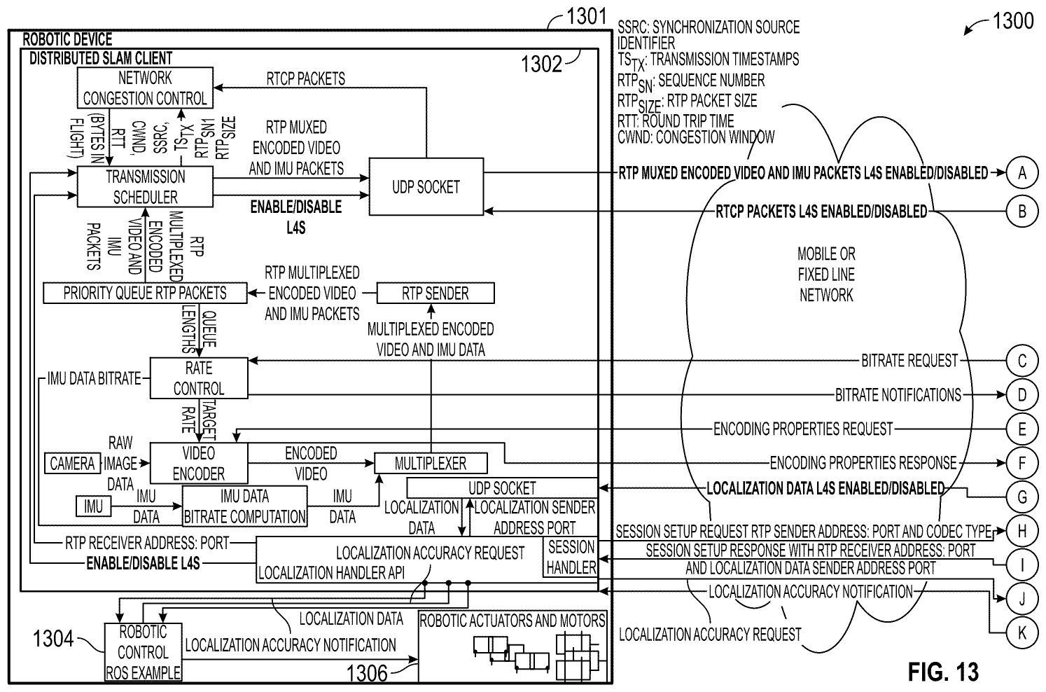

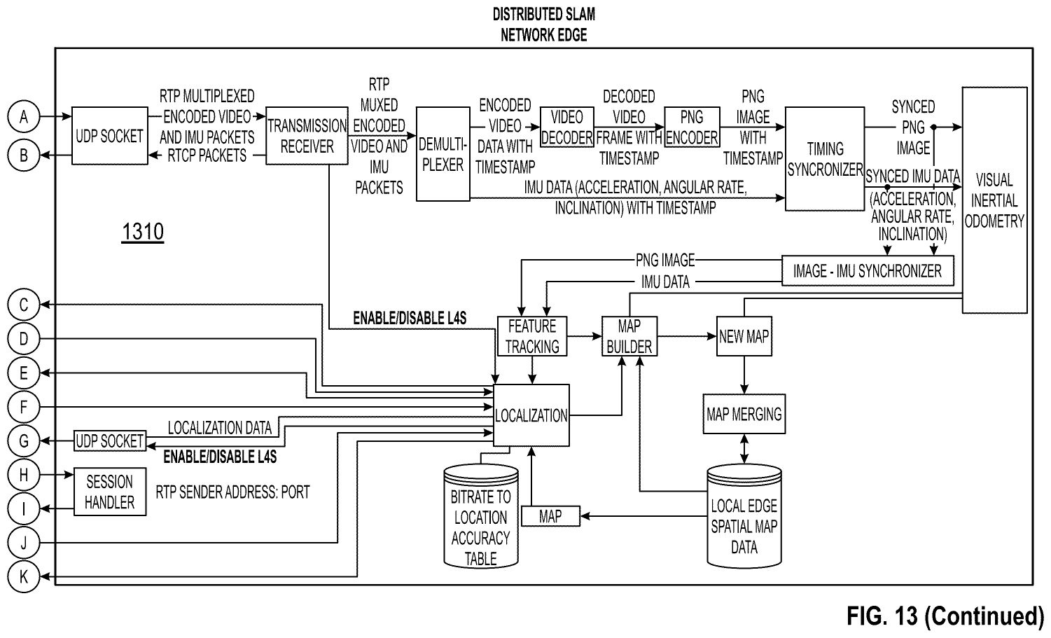

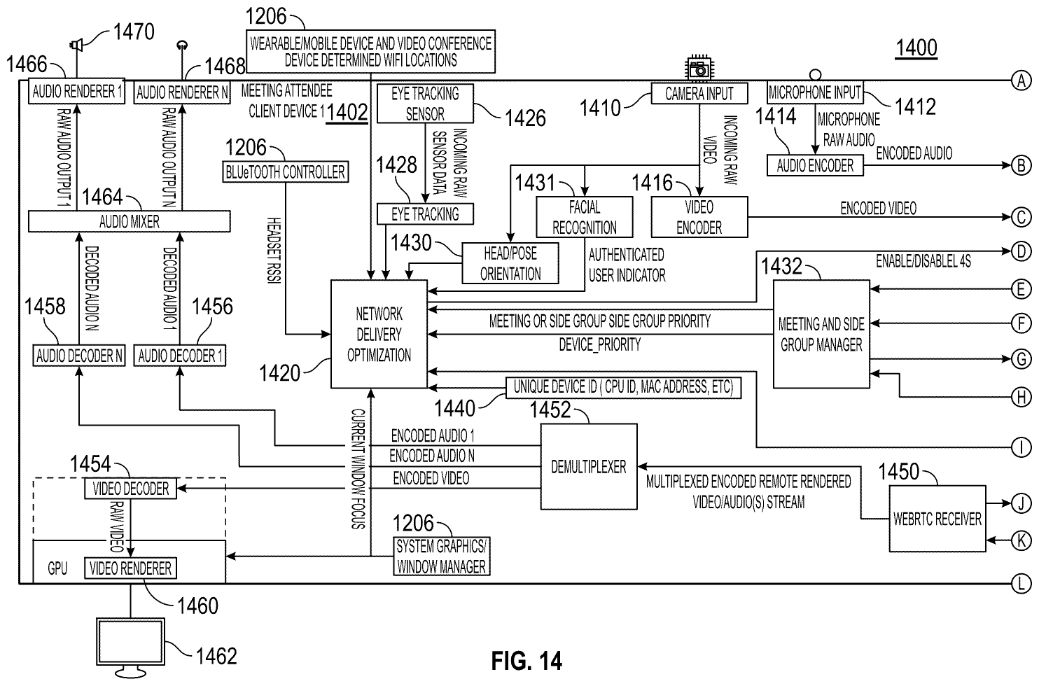

FIG. 13 is an illustrative architecture for a system 1300 having interfaces with SLAM functionalities and/or sub-functionalities, for enabling L4S in a robotic device 1301 using cloud-based SLAM, in accordance with some embodiments for this disclosure. In some embodiments, system 1200 may be a SLAM system for enabling L4S packet markings based on speed, object tracking, and proximity of obstacles to a robot or other device. In some embodiments, system 1300 may be implemented at least in part using the open-source ROS (robot operating system) where MapLab has leveraged and modified SLAM based subfunctions in its implementation, or using any suitable custom implementation thereof, or using any other suitable technique. In some embodiments, the architecture for system 1300 is similar to that of system 1200 (e.g., for an XR device) where video encoding resolution and framerate may be altered based on the bandwidth available and the localization requirements. As discussed in relation to FIGS. 10 and 11A-11B, for a device such as robot, lower localization precision and/or accuracy may be sufficient, or higher localization precision and/or accuracy may be required, based on speed and proximity to other objects or obstacles and obstacle avoidance and/or a size of the robot and/or the other objects or obstacles. L4S packets for the video and IMU data may be enabled on the video and IMU uplink flow and/or may be enabled on the localization within the mapped space on the downlink flow.

As shown in FIG. 13, system 1300 may be implemented in a similar manner as system 1200 of FIG. 12, except that system 1300 may employ robotic device 1301 instead of (or in addition to) XR device 1201 of FIG. 12. Robotic device 1301 may comprise distributed SLAM client 1302. Distributed SLAM client 1302 of FIG. 13 may be implemented in a similar manner as distributed SLAM client 1202 of FIG. 12. System 1300 of FIG. 13 may comprise distributed SLAM network edge server 1310 which may be implemented in a similar manner as distributed SLAM network edge server 1210 of FIG. 12. Session handler 1230 may provide one or more notifications (e.g., localization accuracy notifications), localization accuracy requests, and/or localization data to robotic control robot operating system (ROS), based on which ROS 1304 may transmit instructions to control robotic actuators and motors 1306 (and/or any other suitable components of robotic device 1301), e.g., based on whether a current portion of network traffic requires relatively higher or relatively lower latency.

In some embodiments, in the examples of FIGS. 9-13, the system may minimize localization latency, e.g., by using the first queue to process preferential network traffic, when SLAM client and/or SLAM network edge determines that XR device 1201 or robotic device 1301 is in close proximity to one or more other objects. This may enable minimizing the latency at which localization updates are received.

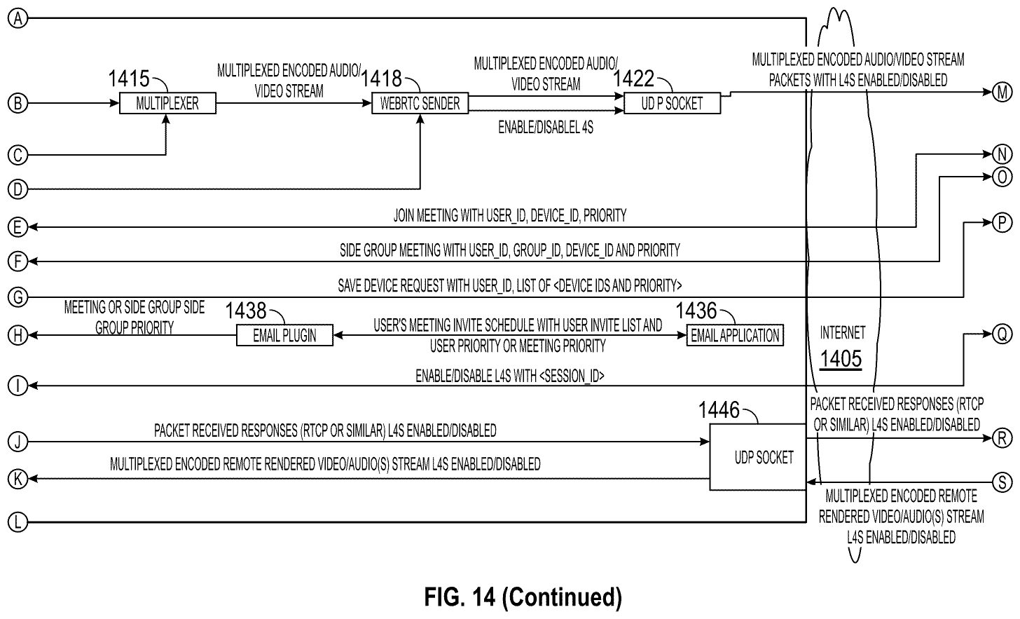

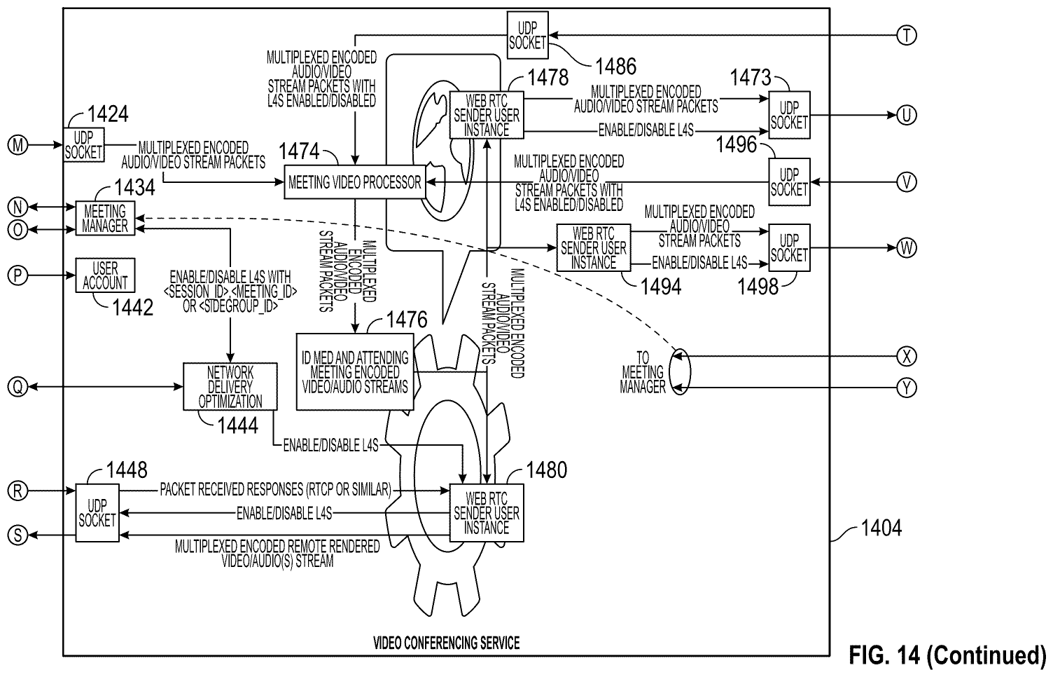

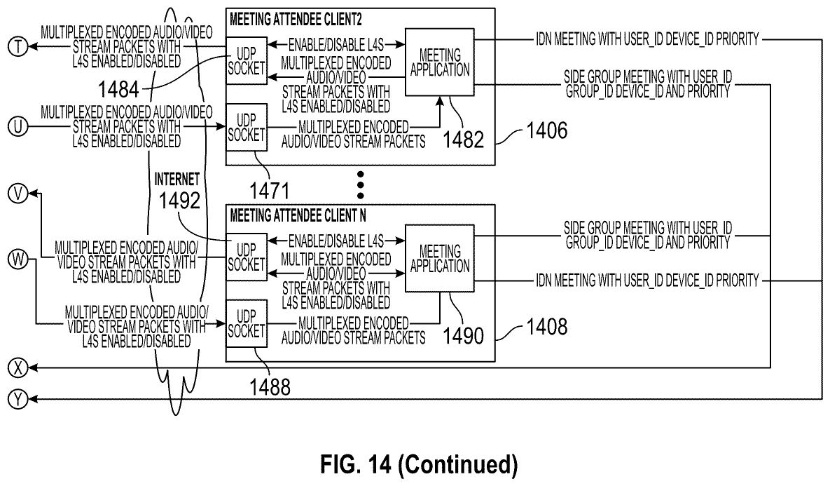

FIG. 14 is an illustrative architecture for a system 1400 for selectively treating portions of network traffic preferentially during a virtual conference, in accordance with some embodiments for this disclosure. System 1400 may comprise meeting attendee client device 1 1402, video conferencing service or server(s) 1404, meeting attendee client device 2 1406, . . . meeting attendee client device n. Video conferencing service or server(s) 1404 may facilitate a video conference between any suitable number of remote participants.

Video conferencing is another area where portions of network traffic may be treated preferentially set. For example, manual settings when setting up a meeting may be based on a set of selected invitees (e.g., based on their physical location such as participating from a different country, where such information may be obtained from an email service server or using any other suitable technique) to a meeting or it could be prioritized for all meeting attendees at the meeting invite level. In some embodiments, system 1400 may set automatic settings based on if a user has enabled video or not. In some embodiments, based on the participant activity within the video conference, network traffic may be treated preferentially (or not). For example, L4S may be disabled if video conference system 1400 detects the participant is distracted (e.g., based on head pose and eye tracking or window pose, and/or based on audio input or lack thereof received from the user), or if system 1400 detects the user has stepped away from his or her device that is joined to the virtual conference. Such detection mechanisms are discussed in more detail in commonly-owned U.S. application Ser. No. 18/207,348, filed Jun. 8, 2023, in the name of Adeia Guides Inc., the contents of which is hereby incorporated by reference herein in its entirety.

In some embodiments, enabling/disabling L4S packet markings may be triggered based on specific events or when a specific functionality is invoked, e.g., when a participant invokes a functionality to share his or her screen with other remote participants of the virtual conference, or when annotation is taking place on a whiteboard, for example. In some embodiments, an application administrator (e.g., IT personnel) may allow the automatic enablement for L4S markings for features of an application (e.g., the feature of the application that is used or invoked triggers the utilization of L4S Packet markings). In one example, the feature associated with the application (e.g., video conferencing application) is an interactive whiteboard. FIG. 14 may provide video conference system 1400 for marking packets to be treated preferentially based on meeting priority, user priority, device priority, side group priority, head pose, user's gaze, window focus, attendee's proximity to the client device, and/or any other suitable factors.

As shown in FIG. 14, client device 1402 may receive camera input 1410 and/or microphone input 1412 of a user participating in the video conference. The raw audio captured by the microphone may be provided to audio encoder 1414, and the incoming raw video from camera 1410 may be provided to video encoder 1416. Multiplexer 1415 may receive encoded audio from audio encoder 1414 and encoded video from video encoder 1416, and perform multiplexing on such encoded video and audio data, and provide the multiplexed encoded audio/video stream to WebRTC sender 1418. UDP socket 1422 may receive an indication of whether to enable or disable L4S for a portion of video conference network traffic from network delivery optimization module 1420, and the multiplexed audio/video stream, and may provide such data to UDP socket 1422, which in turn may provide such data to UDP socket 1424 of server 1404. The indication of whether to enable or disable L4S for a portion of video conference network traffic may be based on any suitable data provided to delivery optimization module 1420, e.g., eye tracking data 1428 gleaned from eye tracking sensor 1426, head/pose orientation data 1430, and/or facial recognition data 1431.

Meeting and side group manager 1432 may transmit a request to meeting manager 1434 of server 1404 to join a meeting (e.g., with user_ID, device_ID, priority) and/or a side group meeting with user_id, group_ID and priority. Meeting and side group manager 1432 may transmit an indication of a meeting or side group priority, and device priority, to network delivery optimization module 1420. Email application 1436 and email plugin 1438 may analyze a user's meeting invite schedule and/or invite list and/or user priority or meeting priority preferences, and transmit such data to meeting and side group manager 1432. A unique device ID 1440 (e.g., CPU ID, mac address, and/or any other suitable identifying data) for client device 1402 may be transmitted to network delivery optimization module 1420. Meeting and side group manager 1432 may transmit to a user account data 1442 for the user of client device 1402, stored at server 1404, data comprising a save device request with user_id, and list of device IDs and priority. Network delivery optimization module 1420 may communicate with network delivery optimization module 1444 of server 1404 whether to enable or disable L4S (or other suitable preferential treatment protocol) with one or more portions of a particular session ID.

UDP socket 1446 of client device 1402 may receive, from UDP socket 1448 of server 1404, multiplexed encoded remote rendered video/audio stream(s) with L4S enabled or disabled. For example, such video and/or audio stream(s) may have originated at locations corresponding to one or more of client device 1406 or 1408 participating in the virtual meeting. Such data may be provided from UDP socket 1446 to WebRTC receiver 1450, which in turn may provide such data to demultiplexer 1452, which may separate the combined audio and video signals, e.g., to transmit encoded video stream(s) to video decoder 1454, and encoded audio stream(s) to audio decoders 1456 and 1458. Video decoder 1454 decodes the video stream(s) and transmits the decoded video data to video renderer 1460, which provides an output of the video conference at display 1462 to the user of client device 1402. Decoded audio output by audio decoders 1456 and 1458 may be transmitted to audio mixer 1464, and audio mixer 1464 transmits audio output to audio renderer 1466 and 1468 for output to the user of client device 1402 via audio output equipment (e.g., speakers or headphones) 1470.

Meeting attendee client device 1406 may receive, at UDP socket 1471, multiplexed encoded audio and video stream packets, e.g., from UDP socket 1473 of server 1404. For example, such packets may have been received at UDP socket 1424 of server 1404, transmitted to meeting video processor 1473, and combined at 1476 with other video and/or audio streams of other conference participants, and such combined data may be transmitted to WebRTC sender user instance 1478, and forwarded to UDP socket 1471 along with an indication to enable or disable L4S for such packets. In some embodiments, network delivery optimization 1444 may provide an indication to enable or disable L4S to webRTC sender user instance 1480, which in turn may transmit an indication to enable or disable L4S to UDP socket 1448, along with the multiplexed encoded remote rendered video and audio stream (e.g., captured at client device 1406 and/or 1408). WebRTC sender user instance 1480 may receive a packet received response (RTCP or other suitable protocol) from UDP socket 1448.

UDP socket 1473 of meeting attendee client device 1406 may transmit the multiplexed encoded audio/video packets to meeting application 1482, which may forward such data, along with an indication to enable or disable L4S, to UDP socket 1484, and such data may be forwarded to UDP socket 1486 of server 1404, which in turn may forward such data to meeting video processor 1474. UDP socket 1488 of client device 1408 may receive multiplexed audio/video stream packets with L4S enabled or disabled to UDP socket 1488, which may forward such data to meeting application 1490, which in turn may forward such data to UDP socket 1496. WebRTC sender user instance 1494 may provide an indication to enable or disable L4S for multiplexed encoded audio/video stream packets to UDP socket 1498. In some embodiments, meeting application 1490 of client device 1408 and meeting application 1482 may transmit a request to join a meeting with a user_ID, device_ID, priority data and/or other suitable data, and/or a side group meeting with user_ID, group_ID, and priority data and/or other suitable data, to meeting manager 1434.

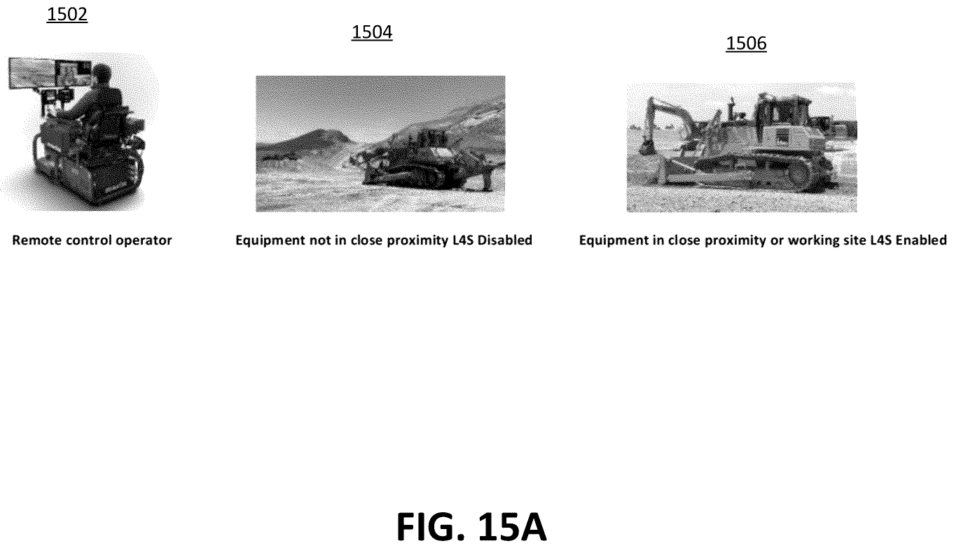

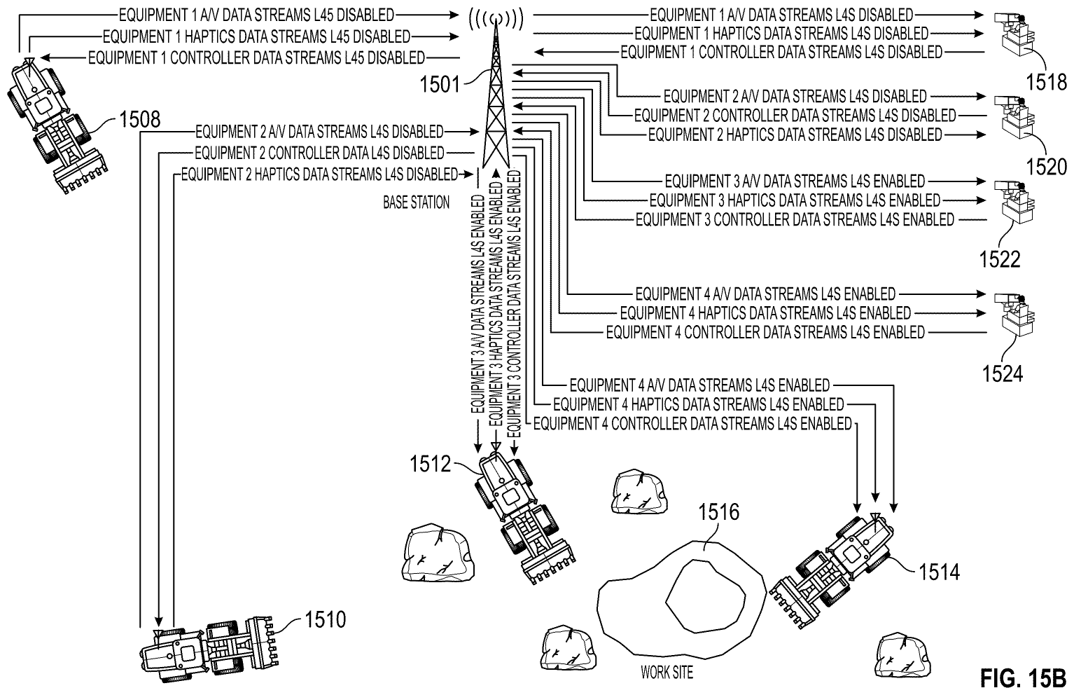

As shown in FIG. 15A, a remote control device controlled by operator 1502 may be configured to control construction equipment (e.g., excavation equipment) or any other suitable equipment, from a remote location (from 60 miles away or less, or any other suitable distance away) over a mobile network or any other suitable network. There may be cases where extreme low latency may not be required for controlling such construction equipment, and others where it may be required. For example, as shown at 1504, if a bulldozer or dozer (or any other suitable construction equipment) is moving from one work site to another with no objects in close proximity, a relatively low latency may be sufficient for network communications between the remote control and the bulldozer, e.g., since the equipment may be moving slowly, 50-100 ms latency may be sufficient, and thus L4S may be disabled for the network communications. On the other hand, as shown at 1506, if the system determines that the bulldozer is operating in close proximity of another object or the dozer has reached its working site, the latency may need to be decreased on both the video delivery from the dozer and the controller input from the remote-control operator, and thus L4S may be enabled for the network communications.

FIG. 15A shows a sequence of images of the remote operator 1502 with multiple camera views 1504 and 1506 of the bulldozer. 1504 is an example of a remote control bulldozer relocating to another working location and/or having no equipment (or minimal other objects) in close proximity. 1506 is an example of a remote control dozer moving into an area with other equipment/objects. In each of these cases, L4S (or other preferential treatment of network traffic) may be enabled or disabled based on “working mode” or proximity to other objects. FIG. 15B is an example of L4S stream enablement (or enablement of other preferential treatment of network traffic) based on work site proximity and obstacle proximity.

As shown in FIG. 15B, construction equipment 1508 may transmit, to base station 1501, equipment audio visual data streams with L4S disabled, e.g., due to construction equipment 1508 having relocating to another working location and/or having no equipment (or minimal other objects) in close proximity, and construction equipment 1508 may transmit, to base station 1501, an indication to disable L4S for haptics data streams, and base station 1501 may transmit an indication that controller data streams have L4S disabled. Similar data flows may be transmitted and received between construction equipment 1510 and base station as for construction equipment 1508. On the other hand, based on determining that construction equipment 1512 and 1514 are proximate to work site 1516 and/or each other and/or other objects (e.g., of a certain size, or a certain number of objects), base station 1501 may transmit indications to construction equipment 1512, 1514 to enable L4S preferential treatment for audio visual data streams and haptic data streams and controller data streams. Data streams transmitted by or received by remote control operators 1522 and 1524 for construction equipment 1512 and 1514, respectively, may be L4S enabled (e.g., based on such construction equipment having proximity to a work site or other objects). On the other hand, data streams transmitted by or received by remote control operators 1520 and 1518 for construction equipment 1508 and 151, respectively, may be L4S disabled (e.g., based on such construction equipment lacking proximity to a work site or other objects).

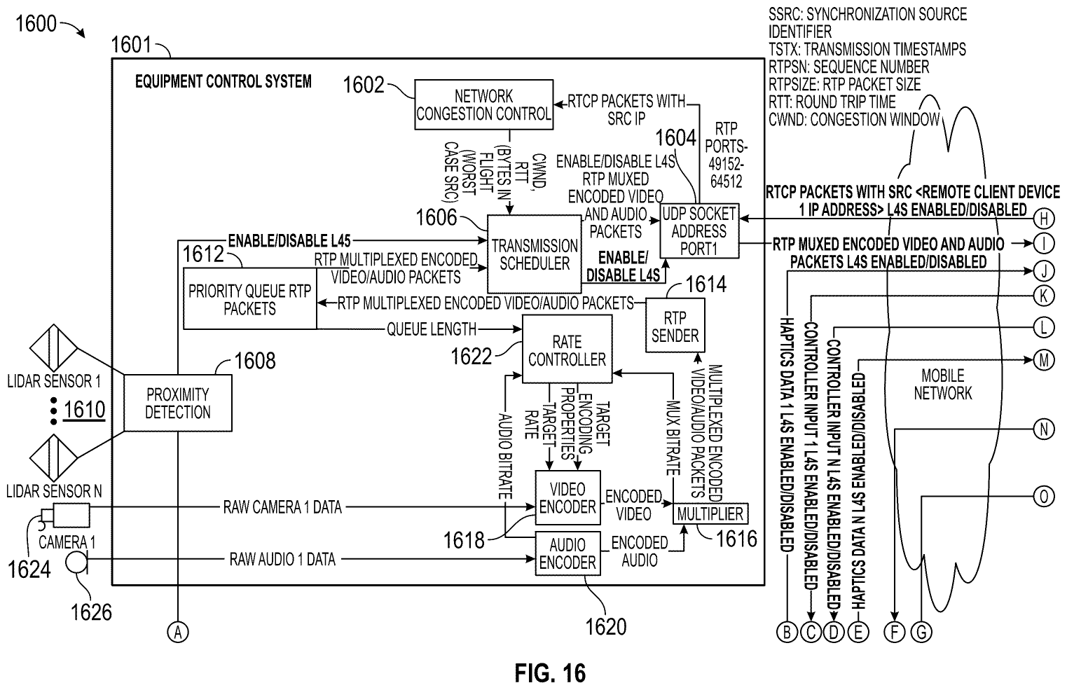

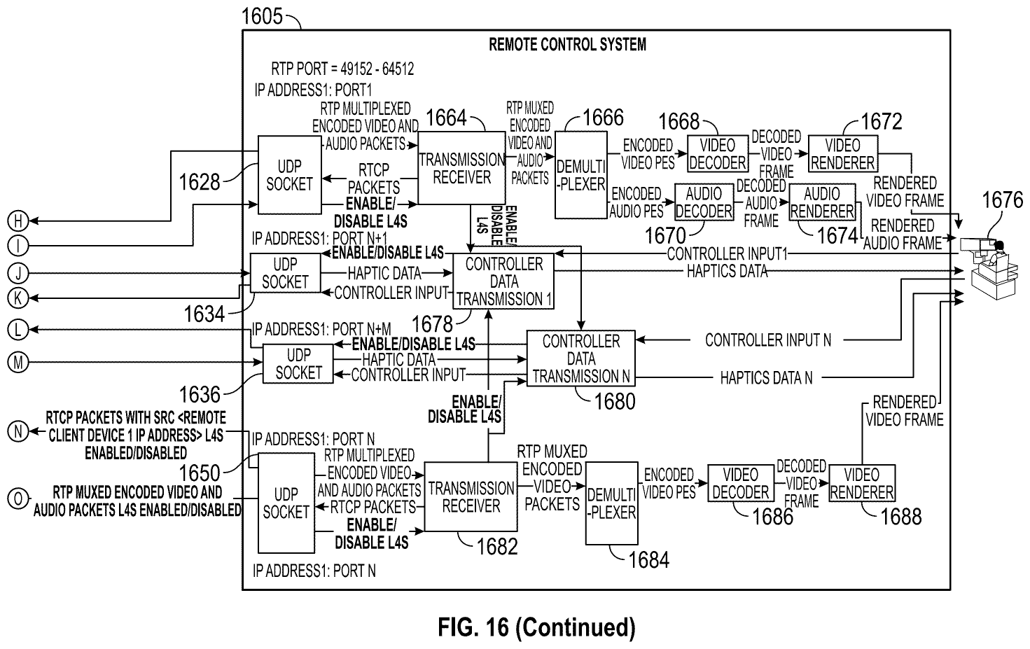

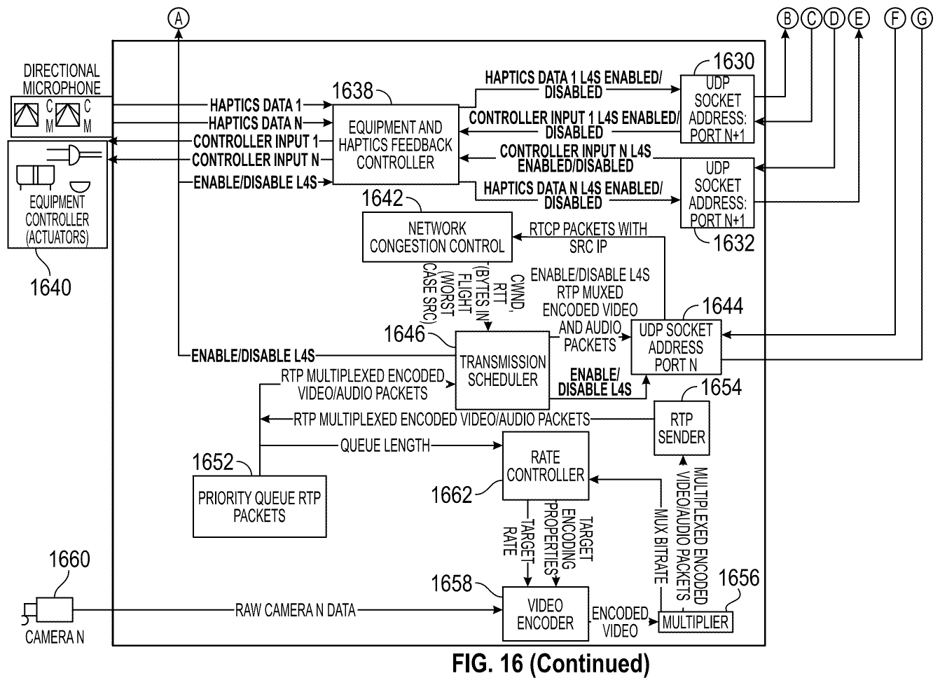

FIG. 16 shows an illustrative architecture for a system 1600 for prioritized stream delivery with L4S based on remote vehicle control with proximity of objects, in accordance with some embodiments of this disclosure. Equipment control system 1601 may comprise network congestion control 1602, which may be configured to receive RTCP packets with SRC IP address from UDP socket 1604, based on RTP multiplexed encoded video and audio packets received from transmission scheduler 1606. Proximity detection module 1608 may, based on measurements from sensors (e.g., lidar sensors 1610), transmit an indication whether to enable or disable L4S for certain network traffic. UDP socket address 1604 may transmit RTP multiplexed encoded video and audio packets that are L4S enabled or disabled to UDP socket 1628 of remote control system 1605, and UDP socket address 1604 may receive RTCP packets with SRC: <remote client device 1 IP address> L4S enabled or disabled from UDP socket 1628.

Priority queue for RTP packets 1612 may receive the RTP multiplexed encoded video and audio packets from RTP sender 1614, which in turn was received by RTP sender 1614 from multiplexer 1616. Multiplexer 1616 may combine encoded video received from video encoder 1618 and encoded audio received from audio encoder 1620 to obtain the multiplexed bitrate transmitted to rate controller 1622 and to obtain the multiplexed encoded video and audio packets transmitted to RTP sender 1614. Video encoder 1618 may encode camera data received from camera 1624 and audio data received from microphone 1626. Priority queue 1612 may transmit a queue length to rate controller 1622, which may provide encoding properties and the target rate to encoders 1618 and/or 1620, and may receive audio bitrate information from audio encoder 1620.

UDP sockets 1630 and 1632 of equipment control system 1601 may receive, from UDP socket 1634 and UDP socket 1636, respectively, of remote control system 1605, controller input (e.g., received from remote operator 1676 of construction equipment controlled by control system 1601) that is enabled or disabled with respect to L4S. UDP sockets 1630 and 1632 of equipment control system 1601 may transmit, to UDP socket 1634 and UDP socket 1636, respectively, of remote control system 1605, haptics data that is enabled or disabled with respect to L4S. UDP sockets 1630 and 1632 may receive such haptics data from equipment and haptics feedback controller 1638, and UDP sockets 1630 and 1632 may transmit to equipment and haptics feedback controller 1638 controller input received from UDP sockets 1634 and 1636. Such haptics data may be received by equipment and haptics feedback controller 1638 from equipment controller actuators 1640, and the controller inputs may be provided to controller actuators 1640.

Equipment control system 1601 may comprise network congestion control 1642, which may be configured to receive RTCP packets with SRC IP address from UDP socket 1644, based on RTP multiplexed encoded video and audio packets received from transmission scheduler 1646. UDP socket address 1644 may transmit RTP multiplexed encoded video and audio packets that are L4S enabled or disabled to UDP socket 1650 of remote control system 1605, and UDP socket address 1644 may receive RTCP packets with SRC: <remote client device 1 TP address> L4S enabled or disabled from UDP socket 1650. Priority queue for RTP packets 1652 may receive the RTP multiplexed encoded video and audio packets from RTP sender 1654, which in turn was received by RTP sender 1654 from multiplexer 1656. Multiplexer 1656 may combine encoded video received from video encoder 1658 to obtain the multiplexed bitrate transmitted to rate controller 1662 and to obtain the multiplexed encoded video and audio packets transmitted to RTP sender 1654. Video encoder 1658 may encode camera data received from camera 60. Priority queue 1652 may transmit a queue length to rate controller 1662, which may provide encoding properties and the target rate to encoder 1658.

UDP socket 1628 may transmit the RTP multiplexed encoded video and audio packets, and the indication of whether L4S is enabled or disabled, to transmission receiver 1664, which may transmit the RTCP packets to UDP socket 1628. Transmission receiver 1664 may forward the RTP multiplexed encoded video and audio packets to demultiplexer 1666, which may obtain encoded video PES and audio PES and transmit the encoded video PES to video decoder 1668 and transmit encoded audio PES to audio decoder 1670. Video decoder 1668 may transmit decoder video frame(s) to video renderer 1672, and may transmit decoded audio frame(s) to audio renderer 1674. Remote control operator 1676 may receive the rendered video frame and rendered audio frames of the construction equipment (e.g., at the work site or traveling between work sites) from video renderer 1672 and audio renderer 1674.

UDP socket 1634 may transmit haptic data to controller data transmission module 1678, and UDP socket 1634 may receive the controller input from controller data transmission module 1678. Such controller input may be received by controller data transmission module 1678 from remote control operator 1676. Similarly, controller data transmission n 1680 may receive haptic data from UDP socket 1636 and controller data transmission n 1680 may transmit controller input, received from remote operating equipment 1676, to UDP socket 1636, and controller data transmission n 1680 may transmit the haptic data to remote control operator 1676. In some embodiments, L4S (or another suitable preferential treatment technique) may be enabled for network data corresponding to controller inputs received from controller data transmission module 1678 and/or controller data transmission module 1680, based on incoming RTP audio/video network packets being L4S enabled (or another suitable preferential treatment technique), and L4S (or disabled for another suitable preferential treatment technique) may be disabled for network data corresponding to controller inputs received from the user, based on incoming RTP audio/video network packets being L4S disabled (or disabled for another suitable preferential treatment technique).

UDP socket 1650 may transmit the RTP multiplexed encoded video and audio packets, and the indication of whether L4S is enabled or disabled, to transmission receiver 1682, which may transmit the RTCP packets to UDP socket 1650. Transmission receiver 1682 may forward the RTP multiplexed encoded video and audio packets to demultiplexer 1684, which may obtain encoded video PES transmit the encoded video PES to video decoder 1668. Video decoder 1686 may transmit decoder video frame(s) to video renderer 1688. Remote control operator 1676 may receive the rendered video frame of the construction equipment (e.g., at the work site or traveling between work sites) from video renderer 1688.

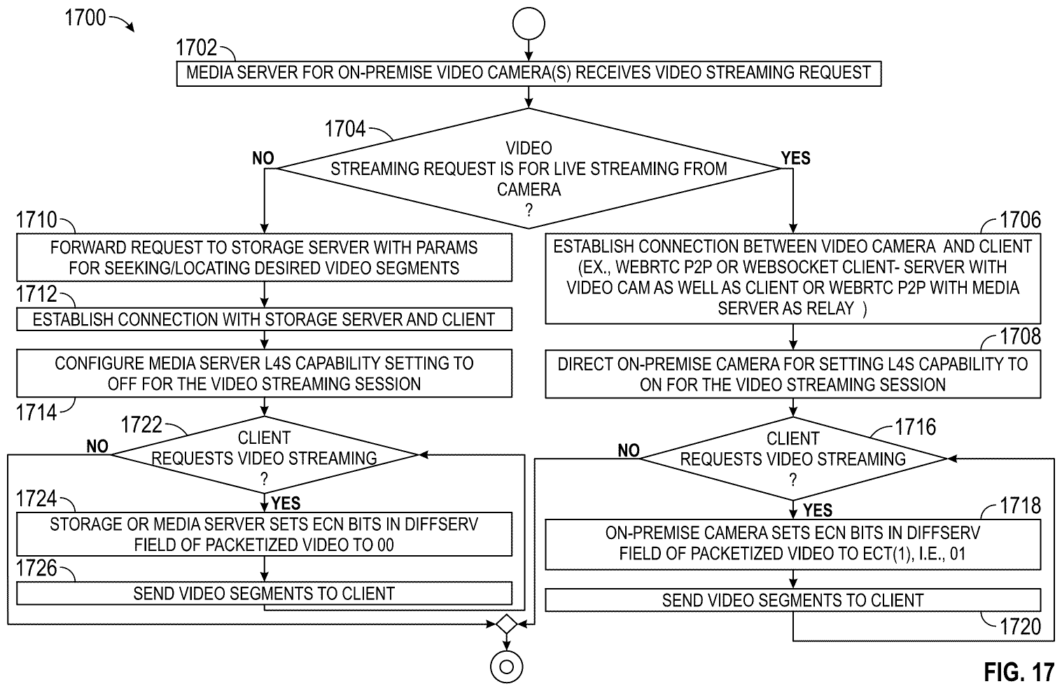

FIG. 17 shows a flowchart of an illustrative process 1700 for selectively enabling L4S for a video streaming request based on whether it is for a live view of an on-premises camera, in accordance with some embodiments of this disclosure. In various embodiments, the individual steps 1702-1726 of process 1700 may be implemented by one or more components of the devices, methods, and systems of FIGS. 1-16 and 18-22 and may be performed in combination with any of the other processes and aspects described herein. Although the present disclosure may describe certain steps 1702-1726 of process 1700 (and of other processes described herein) as being implemented by certain components of the devices, methods, and systems of FIGS. 1-16 and 18-22, this is for purposes of illustration only, and it should be understood that other components of the devices, methods, and systems of FIGS. 1-16 and 18-22 may implement those steps 1702-1726 instead.

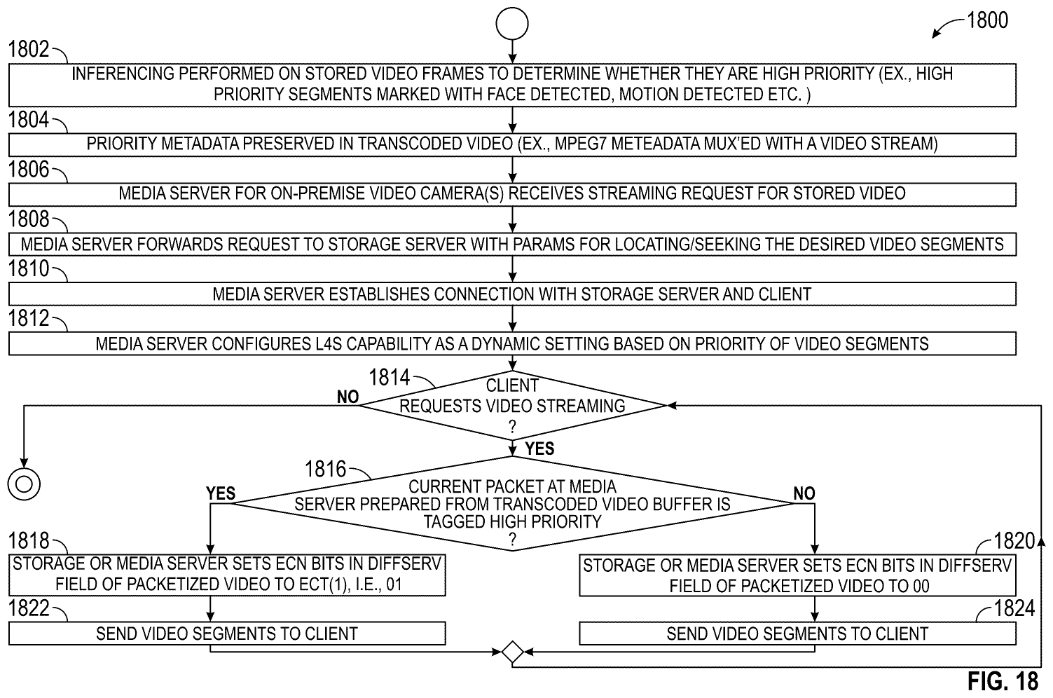

FIG. 18 shows a flowchart of an illustrative process 1800 for selectively enabling L4S for a video streaming request based on priority metadata of the video, in accordance with some embodiments of this disclosure. In various embodiments, the individual steps 1802-1824 of process 1800 may be implemented by one or more components of the devices, methods, and systems of FIGS. 1-17 and 19-22 and may be performed in combination with any of the other processes and aspects described herein. Although the present disclosure may describe certain steps 1802-1824 of process 1800 (and of other processes described herein) as being implemented by certain components of the devices, methods, and systems of FIGS. 1-17 and 19-22, this is for purposes of illustration only, and it should be understood that other components of the devices, methods, and systems of FIGS. 1-17 and 19-22 may implement those steps 1802-1824 instead.

As shown in FIGS. 17-18, the techniques described herein may leverage key characteristics of a request or of the metadata associated with the request to selectively enable L4S packet markings during transport of a video stream from (or associated with) an on-premises camera (e.g., in-home camera, surveillance camera, or any other suitable camera or sensor) and/or storage associated with such on-premises camera.

As shown in FIG. 17, when a client (a user) requests a video from the on-premises camera at 1702, the media server (e.g., cloud server 124 of FIG. 1) checks (at 1704) whether the desired video is a live view or a pre-recorded view. If the requested view is live, then the media server architects a connection between the video camera and the user (at 1706). This may be done using webRTC as a peer-to-peer connection, with the media server as an intermediary (a relay), another protocol such as WebSockets, and/or using any other suitable technique. Once established, the media server (at 1708) directs the on-premises camera to turn on L4S capability marking for this stream, as there is an expectation of low latency delivery for this stream. On the other hand, if the requested video stream is pre-recorded (e.g., saved earlier as a clip when motion was detected), then the media server retrieves (at 1710) the stream from storage, and L4S-capable packet markings may not be required as there may not be an expectation of low latency, as shown at 1712-1714. In this example, if the network experienced congestion and converted the ECN bits to CE, then the sender (e.g., the on-premises camera or the media server/video storage) may reduce the video quality, thus throttling throughput.

At 1716, upon determining that the client device has requested video streaming, processing may proceed to 1718, where the on-premises camera may be caused to set ECN bits in DiffServ field of packetized video to ECT(1), i.e., 01, and at 1720, video segments may be sent to the client device. At 1722, the system may determine whether the client requests video streaming, and if so, at 1724 may cause storage or the media server to set ECN bits in DiffServ field of packetized video to 00. At 1726, the system may cause video segments to be sent to the client.

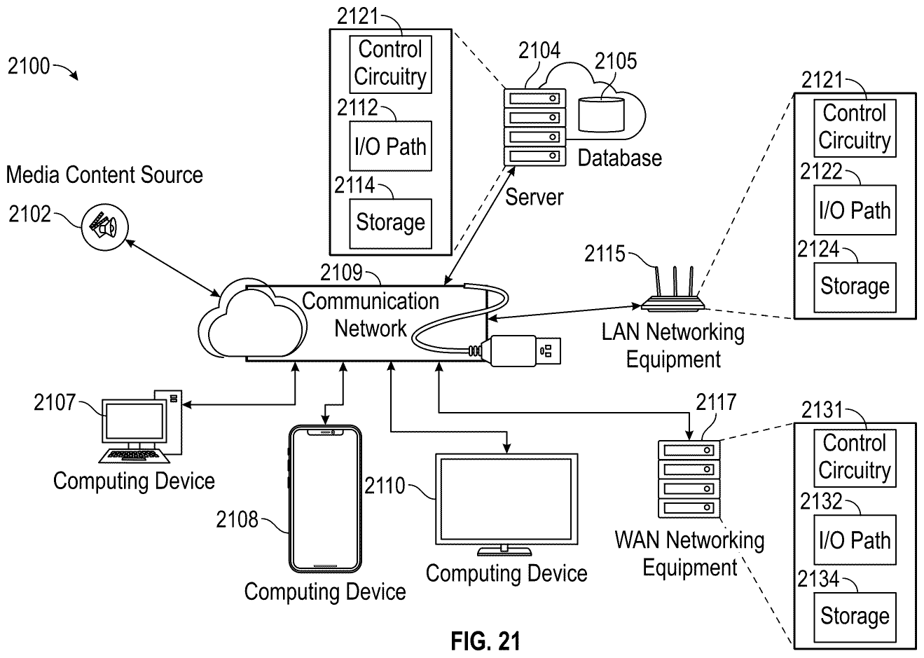

FIG. 18 depicts an embodiment in which the user requests, for example, a pre-recorded video stream. In the example of FIG. 18, at 1802, inferencing may be performed on such pre-recorded stream to tag higher priority segments or areas in the video. For example, portions of video with higher priority may include areas where motion, faces, and/or objects of interest have been detected. At 1804, the system may cause priority metadata to be preserved in transcoded video (e.g., MPEG-7 metadata multiplexed with a video stream). At 1806, a media server for on-premise video camera(s) may receive a streaming request for stored video, and at 1808, the media server may forward the request to a storage server with parameters for locating or seeking the desired video segments. At 1810, the media server may establish a connection with the storage server (e.g., server 2104 of FIG. 21) and the client, and at 1812, configure L4S capability as a dynamic setting based on priority of video segments. For example, the media server may then mark the packetized video of higher priority areas as L4S-capable, thus ensuring that they are delivered with lower latency. For example, regions where saliency is relatively low may not benefit from the enhanced higher priority queue treatment, while higher priority video frames benefit from preferential treatment. Lower latency delivery of more salient video thus reduces packet drop probability in network congestion which in turn reduces frame loss and enhances the customer experience. In some embodiments, near-real time inferencing may be available, to implement the techniques of FIG. 18 in live streaming applications.

At 1814, the system may determine whether the client requests video streaming. If so, processing may proceed to 1816, where the system may determine whether a current packet at the media server prepared from transcoded video buffer is tagged as higher priority. If so, processing proceeds to 1818; otherwise, processing proceeds to 1820. At 1818, the storage or media server (e.g., media content source 2102 of FIG. 21) sets ECN bits in Diffserv field of packetized video to ECT(1), i.e., 01. Otherwise, at 1820, the storage or media server (e.g., media content source 2102 of FIG. 21) sets ECN bits in Diffserv field of packetized video to 00. At 1822, the system may send video segments to the client device, based on the processing performed at 1818. At 1824, the system may send video segments to the client device, based on the processing performed at 1820.

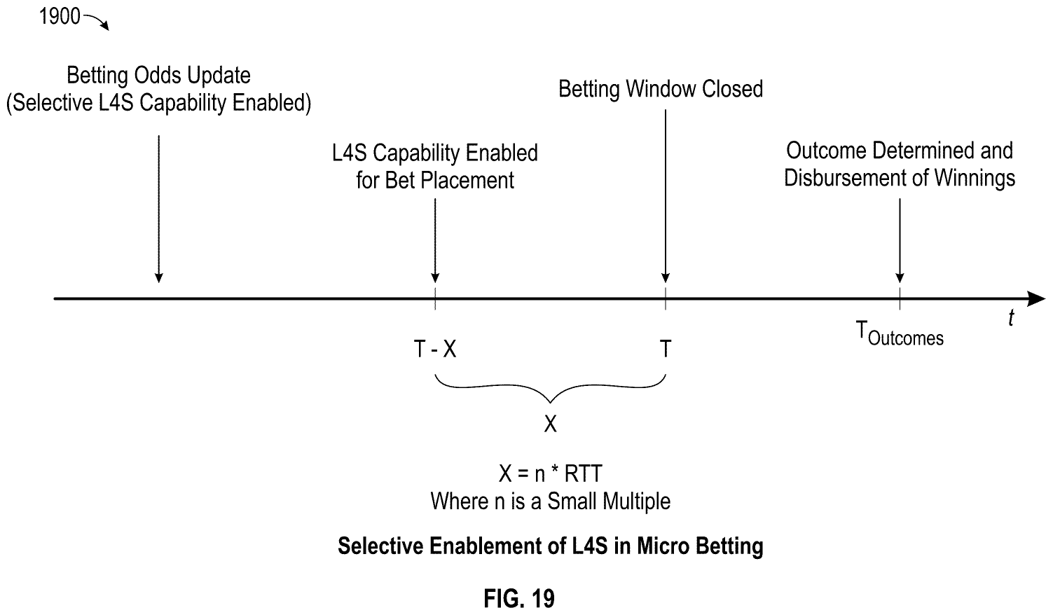

FIG. 19 shows an illustrative example 1900 of selectively treating network traffic as preferential in the context of placing wagers (e.g., micro-betting) over a network, in accordance with some embodiments of this disclosure. For example, L4S capability (or another mechanism for treating network traffic preferentially) may be turned on selectively enabled in micro-betting applications. For example, in a circumstance where a small time-window exists when a micro-bet is open for an outcome that may occur in the immediate future, API calls made based on input received from the bettors to a micro-betting platform for placing bets (e.g., bettors stakes and outcomes on which the stakes are placed), as well as the API calls acknowledging the placement of these bets, must be executed with expediency. Thus, if a chain of events to determine an outcome is expected to begin at time t=T, then the betting app client can turn on L4S marking for packets that represent bet placement at time t=T−X, where X is the total amount of time that L4S capability is turned on, while time t=T represents the time when the platform no longer takes any more bets on the outcome.

In some embodiments, based at least in part on receiving and accepting a bet, the platform returns its acknowledgement with L4S packet marking turned on, if the bet placement packets were received with L4S on. By implementing this mechanism, the betting platform and client apps may give preferential treatment to the placement of bets in comparison to other types of data such as status/score updates, video, chat and/or any other data. If upstream congestion were experienced in the network and CE bits were turned on, then, while the current bet would still go through, the client app may become aware of this, and reduce sending further data to the platform such as frequent requests for status updates or other data. If the CE bits were turned on in the downstream when the platform were acknowledging the successful placement of a bet, then the platform may become aware of the downstream congestion and may reduce the frequency of its information updates to the client.

In some embodiments, a betting platform (or an odds generation platform) may selectively turn on L4S capability packet markings when an odds update is being sent to clients. Odds affect the actual winnings in a bet. Thus, if a user bets on an outcome with stagnant odds, then their bet may not be accepted. To ensure that the odds are speedily updated for users looking to place bets on an outcome associated with an event, the platform can send odds updates with L4S capability turned on. This minimizes rejection of bets by the platform due to stagnant odds.

In some embodiments, the techniques described herein apply to explicit congestion notification, whether that leads to a scalable response (requirement from a sender for L4S capability), or any other response, albeit non-scalable (applicable for ECT(1) or ECT(0) markings by sender). The table below provides a non-limiting summary of applications enabled by the techniques described herein, along with the suggested responses by a sender when the network marks the “CE” bits due to congestion.

| | Use case for | | | |
|---|---|---|---|---|
| | turning on | | | CE Response |
| Category | L4S markings | Sender | Receiver | by sender |
| Cloud Gaming | L4S on when low | Cloud game engine | Client device | RTP sender or |
| | latency required | encoded video | receiving encoded | TCP sender |
| | (FPS fighting) | | game engine video | decreases video |
| | off when low/no | | | bitrate and |
| | action (cutscenes, | | | adjust resolution |
| | exploration) | | | and/or framerate |
| Cloud Gaming | L4S on when low | Client device | Server receiving | Reduce |
| | latency required | controller input | controller input | controller |
| | (FPS fighting) | to game engine | from client device | sampling rate |
| | off when low/no | | | |
| | action (cutscenes, | | | |
| | exploration) | | | |
| Multiplayer | L4S on when low | Console or PC | Client device | RTP sender or |
| Console Game | latency required | game engine | receiving Console | TCP sender |
| Streaming | (FPS fighting) | encoded video | or PC encoded | decreases video |
| with Remote | off when low/no | | game engine video | bitrate and |
| Players | action (cutscenes, | | | adjust resolution |
| | exploration) | | | and/or framerate |
| | L4S on only when | | | based on all |
| | all players have | | | client devices |
| | L4S capability | | | latency and |
| | end-to-end | | | jitter |
| Multiplayer | L4S on when low | Client device | Game Console or | Reduce |
| Console Game | latency required | controller input | PC receiving | controller |
| Streaming | (FPS fighting) | to game engine | controller input | sampling rate |
| with Remote | off when low/no | | from client device | for effected |
| Players | action (cutscenes, | | | client device |
| | exploration) | | | |
| | L4S on only when | | | |
| | all players have | | | |
| | L4S capability | | | |
| | end-to-end | | | |
| Multiplayer | On when all | Multiplayer server | Client device | Decrease update |
| Gaming | multiplayer user | sending multiplayer | receiving | frequency with |
| | sessions have | game data to client | multiplayer game | Loss of player |
| | end-to-end L4S | devices | data from | fairness and any |
| | support, off | | multiplayer server | client |
| | otherwise. | | | experiencing |
| | On when enabling | | | high downlink |
| | fairness for select | | | latency and |
| | multiplayer sessions | | | jitter will |
| | | | | experience |
| | | | | decreased user |
| | | | | experience (UX) |
| | | | | and fairness |
| Multiplayer | On when all | Client device | Multiplayer server | Decrease update |
| Gaming | multiplayer user | sending multiplayer | receiving | frequency with |
| | sessions have | game data/player | multiplayer game | loss of player |
| | end-to-end L4S | control to | data/player control | fairness/QoE for |
| | support, off | multiplayer server | from players in | player |
| | otherwise. | | multiplayer session | experiencing |
| | On when enabling | | | higher upstream |
| | fairness for select | | | latency and |
| | multiplayer sessions | | | bandwidth. |
| SLAM XR | L4S on or off | SLAM XR client | SLAM cloud server | RTP sender or |
| | based on | device sending | receiving IMU, | TCP sender |
| | proximity and | IMU, encoded | encoded video and | decreases video |
| | speed of device | video and (optional | (optional LIDAR | bitrate and |
| | and/or physical | LIDAR data) | data) from XR | adjust resolution |
| | objects and/or | | Device | and/or framerate |
| | rendered | | | and reports to |
| | virtual objects. | | | client device |
| | | | | decrease in |
| | | | | localization |
| | | | | accuracy |
| SLAM XR | L4S on or off | Cloud based SLAM | Cloud based XR | Loss of |
| | based on | server sending | client device | localization |
| | proximity and | spatial coordinates/ | receiving spatial | update |
| | speed of device | localization data | coordinates/ | frequency |
| | and/or physical | to XR device | localization data | |
| | objects and/or | | | |
| | rendered | | | |
| | virtual objects. | | | |
| SLAM | L4S on or off | SLAM robotics | SLAM cloud server | RTP sender or |
| Robotics Or | based on | device/autonomous | receiving IMU, | TCP sender |
| Automotive | proximity and | auto sending IMU, | encoded video and | decreases video |
| | speed of device | encoded video and | (optional LIDAR | bitrate and |
| | and/or objects | (optional LIDAR | data) | adjust resolution |
| | | data) | | and/or framerate |
| | | | | and reports to |
| | | | | client device |
| | | | | decrease in |
| | | | | localization |
| | | | | accuracy |
| SLAM | L4S on or off | Cloud based SLAM | Cloud based | Loss of |
| Robotics Or | based on | server sending | robotics device or | localization |
| Automotive | proximity and | spatial coordinates/ | autonomous auto | update |
| | speed of device | localization data | receiving spatial | frequency |
| | and/or objects | to robotics device/ | coordinates/ | |
| | | autonomous auto | localization data | |
| Video | L4S on based on | Meeting cloud | Client device | RTP sender or |
| conferencing | VC participant's | service for | receiving meeting | TCP sender |
| | proximity to | combined meeting | stream(s) | decreases video |
| | meeting device, | video/audio/screen | | bitrate and |
| | participant's | share output | | adjust resolution |
| | attention to | | | and/or framerate |
| | meeting, side | | | |
| | group priority, | | | |
| | device priority | | | |
| | or meeting | | | |
| | priority, video | | | |
| | on/off | | | |
| Video | L4S on based on | Client device | Meeting | RTP sender or |
| conferencing | VC participant's | running meeting | application server | TCP sender |
| | proximity to | app of user's video, | receiving each | decreases video |
| | meeting device, | audio, and screen/ | user's video, audio | bitrate and |
| | participant's | app capture | and screen/app | adjust resolution |
| | attention to | | share | and/or framerate |
| | meeting, side | | | |
| | group priority, | | | |
| | device priority | | | |
| | or meeting | | | |
| | priority, video | | | |
| | on/off | | | |
| Remote | L4S on based on | Remote vehicle | Remote controller | RTP sender or |
| Vehicle | detected and | cameras encoded | video monitors on | TCP sender |
| Control | calculated | video feeds | remote control | decreases video |
| | proximity and | delivered from | device | bitrate and |
| | speed of objects | remote control | | adjust resolution |
| | | vehicle based on | | and framerate |
| | | proximity to job | | |
| | | location, proximity, | | |
| | | and speed of | | |
| | | detected objects | | |
| Remote | L4S on based on | Remote vehicle | Remote control | Reduce each |
| Vehicle | detected and | control input data | vehicle receiving | controller |
| Control | calculated | streams delivered | the remote | sampling rate as |
| | proximity and | to the remote- | controller(s) data | needed |
| | speed of objects | controlled vehicle | streams | |
| On-premises | L4S on when Live | On-premises camera | User client | Reduce video |
| Camera | viewing | | | quality (pixels) |
| viewing | | | | Reduce frame rate |
| On-premises | L4S on when | On-premises camera | User client | Reduce video |
| Camera | viewing high | | | quality (pixels) |
| viewing | priority video | | | Reduce frame rate |
| | | | | Provide video |
| | | | | summary for |
| | | | | recorded video |
| | | | | (if not live) |
| Betting | L4S on when | Betting Platform or | User client | Reduce update |
| | setting | odds calculation | | frequency |
| | betting odds | platform | | Re-request |
| | | | | update odds only |
| | | | | when user is going |
| | | | | to place bet |
| | | | | Indicate in UI |
| | | | | that manual |
| | | | | action is needed |
| | | | | to update odds |
| Betting | L4S on when | User client | Platform | Reduce upstream |
| | betting window | | | communication by |
| | close is | | | reducing requests |
| | approaching | | | for status updates, |
| | | | | odds updates etc. |
| Betting | L4S on when | Platform | User client | Reduce downstream |
| | betting window | | | communication by |
| | close is | | | reducing status/ |
| | approaching | | | score updates, |
| | | | | odds updates, |
| | | | | multimedia such as |
| | | | | video (pixels, |
| | | | | frame rate,) etc. |

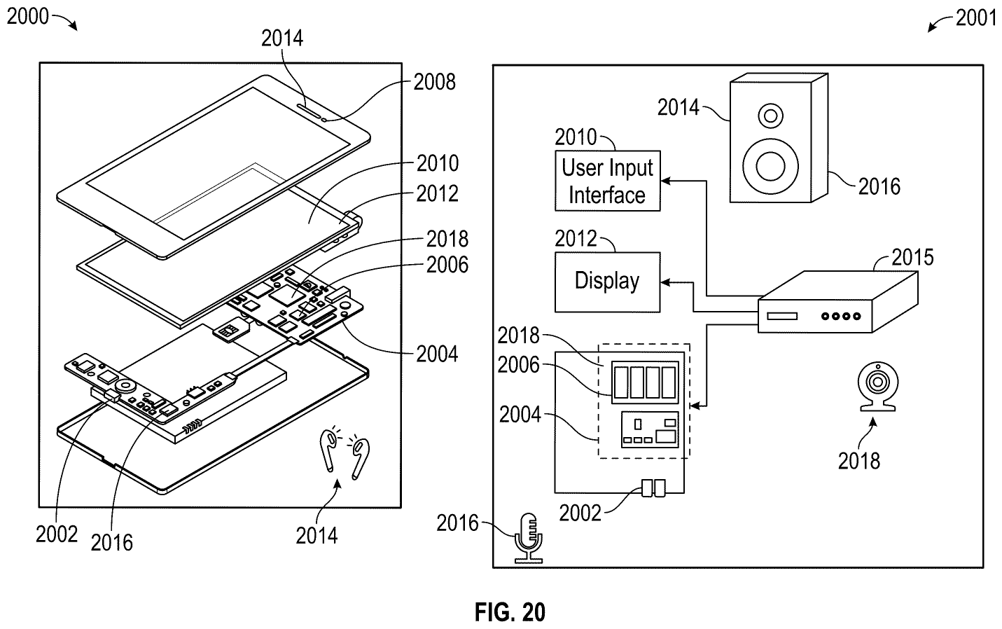

FIGS. 20-21 show illustrative devices, systems, servers, and related hardware for selectively treating portions of network traffic preferentially, in accordance with some embodiments of this disclosure. FIG. 20 shows generalized embodiments of illustrative computing devices 2000 and 2001, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR IMID; or any other suitable computing device; or any combination thereof. In another example, computing device 2001 may be a user television equipment system or device. In some embodiments, computing devices 2000 and 2001 may correspond to, e.g., device 112 or device 114 of FIG. 1.

User television equipment device 2001 may include set-top box 2015. Set-top box 2015 may be communicatively connected to microphone 2016, Audio output equipment (e.g., speaker or headphones 2014), and display 2012. In some embodiments, microphone 2016 may receive audio corresponding to a voice of a user providing input. In some embodiments, display 1012 may be a television display or a computer display. In some embodiments, set-top box 2015 may be communicatively connected to user input interface 2010. In some embodiments, user input interface 2010 may be a remote control device. Set-top box 2015 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 11. In some embodiments, computing device 2000 may comprise any suitable number of sensors (e.g., gyroscope or accelerometer, etc.), and/or a GPS module (e.g., in communication with one or more servers and/or cell towers and/or satellites) to ascertain a location of computing device 2000. In some embodiments, computing device 2000 comprises a rechargeable battery that is configured to provide power to the components of the device.

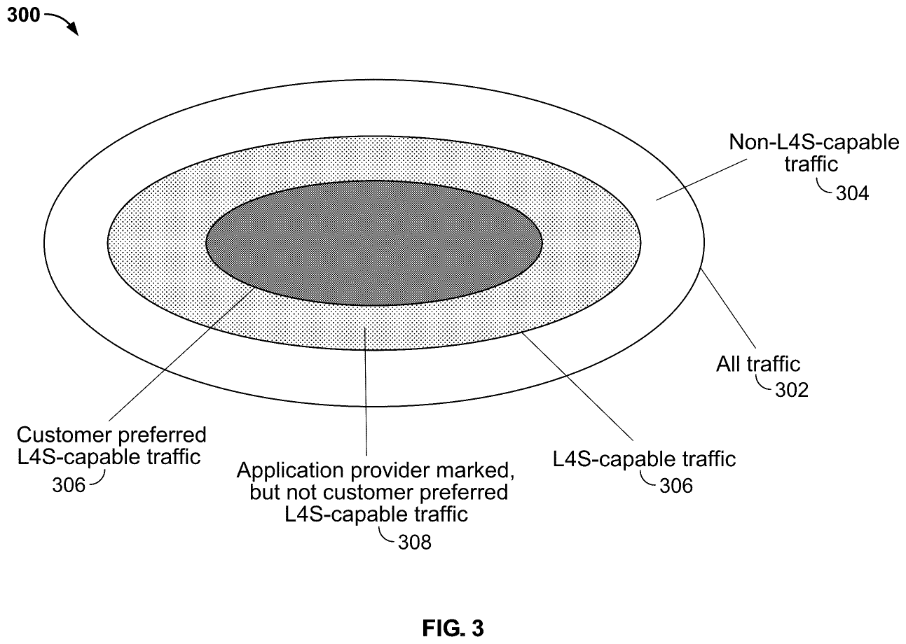

Each one of computing device 2000 and computing device 2001 may receive content and data via input/output (I/O) path 2002. I/O path 2002 may provide content (e.g., broadcast programming, on-demand programming, Internet content, content available over a local area network (LAN) or wide area network (WAN), and/or other content) and data to control circuitry 2004, which may comprise processing circuitry 2006 and storage 2008. Control circuitry 1004 may be used to send and receive commands, requests, and other suitable data using I/O path 2002, which may comprise I/O circuitry. I/O path 2002 may connect control circuitry 2004 (and specifically processing circuitry 2006) to one or more communications paths (described below). I/O functions may be provided by one or more of these communications paths, but are shown as a single path in FIG. 20 to avoid overcomplicating the drawing. While set-top box 1015 is shown in FIG. 3 for illustration, any suitable computing device having processing circuitry, control circuitry, and storage may be used in accordance with the present disclosure. For example, set-top box 2015 may be replaced by, or complemented by, a personal computer (e.g., a notebook, a laptop, a desktop), a smartphone (e.g., computing device 1000), an XR device; a tablet; a network-based server hosting a user-accessible client device; a non-user-owned device; any other suitable device; or any combination thereof.

Control circuitry 2004 may be based on any suitable control circuitry such as processing circuitry 2006. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 2004 executes instructions for the system or application stored in memory (e.g., storage 2008). Specifically, control circuitry 2004 may be instructed by the system or application to perform the functions discussed above and below. In some implementations, processing or actions performed by control circuitry 2004 may be based on instructions received from the system or application.

In client/server-based embodiments, control circuitry 2004 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 2008, and executed by control circuitry 2004 of a computing device 2000.

In some embodiments, the system or application may be a client/server application where only the client application resides on device 2000 (e.g., device 112 or 114 of FIG. 1), and a server application resides on an external server (e.g., server 2104 of FIG. 21). For example, the system or application may be implemented partially as a client application on control circuitry 2004 of device 2000 and partially on server 2104 as a server application running on control circuitry 2111. Server 2104 may be a part of a local area network with one or more of computing devices 2000, 2001 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 2104 and/or an edge computing device), referred to as “the cloud.” Device 2000 may be a cloud client that relies on the cloud computing capabilities from server 2104 to determine whether processing (e.g., at least a portion of virtual background processing and/or at least a portion of other processing tasks) should be offloaded from the mobile device, and facilitate such offloading. When executed by control circuitry of server 2104, the system or application may instruct control circuitry 2111 to perform processing tasks for the client device and facilitate applying preferential treatment on the WAN to certain network traffic corresponding to data requested by a device on a LAN. The client application may instruct control circuitry 2004 to determine where processing should be performed.

Control circuitry 2004 may include communications circuitry suitable for communicating with a server, edge computing systems and devices, a table or database server, or other networks or servers The instructions for carrying out the above mentioned functionality may be stored on a server (which is described in more detail in connection with FIG. 21. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 21). In addition, communications circuitry may include circuitry that enables peer-to-peer communication of computing devices, or communication of computing devices in locations remote from each other (described in more detail below).

Memory may be an electronic storage device provided as storage 2008 that is part of control circuitry 2004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 2008 may be used to store various types of content described herein as well as the system or application data described above. Nonvolatile memory may also be used (e.g., to launch a boot-up routine and other instructions). Cloud-based storage, described in more detail in relation to FIG. 12, may be used to supplement storage 2008 or instead of storage 2008.

Control circuitry 2004 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 2004 may also include scaler circuitry for upconverting and downconverting content into the preferred output format of computing device 2000. Control circuitry 2004 may also include digital-to-analog converter circuitry and analog-to-digital converter circuitry for converting between digital and analog signals. The tuning and encoding circuitry may be used by computing device 2000, 2001 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 2008 is provided as a separate device from computing device 2000, the tuning and encoding circuitry (including multiple tuners) may be associated with storage 2008.

Control circuitry 2004 may receive instruction from a user by way of user input interface 2010. User input interface 2010 may be any suitable user interface, such as a remote control, mouse, trackball, keypad, keyboard, touchscreen, touchpad, stylus input, joystick, voice recognition interface, or other user input interfaces. Display 812 may be provided as a stand-alone device or integrated with other elements of each one of computing device 1000 and computing device 2001. For example, display 1012 may be a touchscreen or touch-sensitive display. In such circumstances, user input interface 1010 may be integrated with or combined with display 2012. In some embodiments, user input interface 1010 includes a remote-control device having one or more microphones, buttons, keypads, any other components configured to receive user input or combinations thereof. For example, user input interface 1010 may include a handheld remote-control device having an alphanumeric keypad and option buttons. In a further example, user input interface 2010 may include a handheld remote-control device having a microphone and control circuitry configured to receive and identify voice commands and transmit information to set-top box 2015.

Audio output equipment 2014 may be integrated with or combined with display 2012. Display 2012 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 2012. Audio output equipment 1014 may be provided as integrated with other elements of each one of computing device 2000 and computing device 2001 or may be stand-alone units. An audio component of videos and other content displayed on display 2012 may be played through speakers (or headphones) of audio output equipment 2014. In some embodiments, audio may be distributed to a receiver (not shown), which processes and outputs the audio via speakers of audio output equipment 2014. In some embodiments, for example, control circuitry 2004 is configured to provide audio cues to a user, or other audio feedback to a user, using speakers of audio output equipment 2014. There may be a separate microphone 2016 or audio output equipment 2014 may include a microphone configured to receive audio input such as voice commands or speech. For example, a user may speak letters, words, terms and/or numbers that are received by the microphone and converted to text by control circuitry 2004. In a further example, a user may voice commands that are received by a microphone and recognized by control circuitry 2004. Camera 2018 may be any suitable video camera integrated with the equipment or externally connected. Camera 2018 may be a digital camera comprising a charge-coupled device (CCD) and/or a complementary metal-oxide semiconductor (CMOS) image sensor. Camera 2018 may be an analog camera that converts to digital images via a video card.

The system or application may be implemented using any suitable architecture. For example, it may be a stand-alone application wholly-implemented on each one of computing device 2000 and computing device 2001. In such an approach, instructions of the application may be stored locally (e.g., in storage 2008), and data for use by the application is downloaded on a periodic basis (e.g., from an out-of-band feed, from an Internet resource, or using another suitable approach). Control circuitry 2004 may retrieve instructions of the application from storage 2008 and process the instructions to provide the functionality, and generate any of the displays, discussed herein. Based on the processed instructions, control circuitry 2004 may determine what action to perform when input is received from user input interface 2010. For example, movement of a cursor on a display up/down may be indicated by the processed instructions when user input interface 2010 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 2004 may allow a user to provide user profile information or may automatically compile user profile information. For example, control circuitry 2004 may access and monitor network data, video data, audio data, processing data, historical interactions by the user, and/or any other suitable data. Control circuitry 2004 may obtain all or part of other user profiles that are related to a particular user (e.g., via social media networks), and/or obtain information about the user from other sources that control circuitry 2004 may access. As a result, a user can be provided with a unified experience across the user's different devices.

In some embodiments, the system or application is a client/server-based application. Data for use by a thick or thin client implemented on each one of computing device 2000 and computing device 2001 may be retrieved on-demand by issuing requests to a server remote to each one of computing device 2000 and computing device 2001. For example, the remote server may store the instructions for the application in a storage device. The remote server may process the stored instructions using circuitry (e.g., control circuitry 2004) and generate the displays discussed above and below. The client device may receive the displays generated by the remote server and may display the content of the displays locally on computing device 1000. This way, the processing of the instructions is performed remotely by the server while the resulting displays (e.g., that may include text, a keyboard, or other visuals) are provided locally on computing device 2000. Computing device 2000 may receive inputs from the user via input interface 310 and transmit those inputs to the remote server for processing and generating the corresponding displays. For example, computing device 2000 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to computing device 2000 for presentation to the user.

In some embodiments, the system or application may be downloaded and interpreted or otherwise run by an interpreter or virtual machine (run by control circuitry 1004). In some embodiments, system or application may be encoded in the ETV Binary Interchange Format (EBIF), received by control circuitry 2004 as part of a suitable feed, and interpreted by a user agent running on control circuitry 2004. For example, the system or application may be an EBIF application. In some embodiments, the system or application may be defined by a series of JAVA-based files that are received and run by a local virtual machine or other suitable middleware executed by control circuitry 2004. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

FIG. 21 is a diagram of an illustrative system 2100 for providing recommendations for enforcing a data cap for preferential network traffic, in accordance with some embodiments of this disclosure. Computing devices 2107, 2108, 2110 (which may correspond to, e.g., computing device 2000 or 2001) may be coupled to communication network 2109. Communication network 2109 may be one or more networks including the Internet, a mobile phone network, mobile voice or data network (e.g., a 5G, 4G, or LTE network), cable network, public switched telephone network, satellite network, or other types of communication network or combinations of communication networks. Paths (e.g., depicted as arrows connecting the respective devices to the communication network 2109) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 12 to avoid overcomplicating the drawing. In some embodiments, communication network 2109 may correspond to service provider network 102.

LAN networking equipment 2115 may correspond to, for example, networking equipment 106 and/or 108 (e.g., router, gateway, switch, and/or modem and/or other suitable equipment) of FIG. 1. LAN networking equipment 2115 may comprise control circuitry 2121, I/O path 2122, and storage 2124. WAN networking equipment 2117 may correspond to, for example, networking equipment 122 (e.g., a backbone or carrier router or CMTS other suitable networking equipment) of FIG. 1. WAN networking equipment 2117 may comprise control circuitry 2131, I/O path 2132, and storage 2134.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 2109.

System 2100 may comprise media content source 2102, one or more servers 2104, and/or one or more edge computing devices. In some embodiments, system or application may be executed at one or more of control circuitry 2111 of server 2104 (and/or control circuitry of computing devices 2107, 2108, 2110 and/or control circuitry of one or more edge computing devices). In some embodiments, media content source 2102 and/or server 2104 may be configured to facilitate network traffic between computing devices 2107, 2108, 2110 and/or any other suitable computing devices, and/or host or otherwise be in communication (e.g., over network 2109) with one or more application services. In some embodiments, server 2104 may perform actions to facilitate processing network traffic based on received user input as described herein.

In some embodiments, server 2104 may include control circuitry 2111 and storage 2114 (e.g., RAM, ROM, Hard Disk, Removable Disk, etc.). Storage 2114 may store one or more databases. Server 2104 may also include an input/output path 2112. I/O path 2112 may provide network traffic information, user preferences, device information, or other data, over a LAN or WAN, and/or other content and data to control circuitry 2111, which may include processing circuitry, and storage 2114. Control circuitry 2111 may be used to send and receive commands, requests, and other suitable data using I/O path 2112, which may comprise I/O circuitry. I/O path 2112 may connect control circuitry 2111 (and specifically control circuitry) to one or more communications paths.

Control circuitry 2111 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 2111 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 2111 executes instructions for an emulation system application stored in memory (e.g., the storage 2114). Memory may be an electronic storage device provided as storage 2114 that is part of control circuitry 2111.

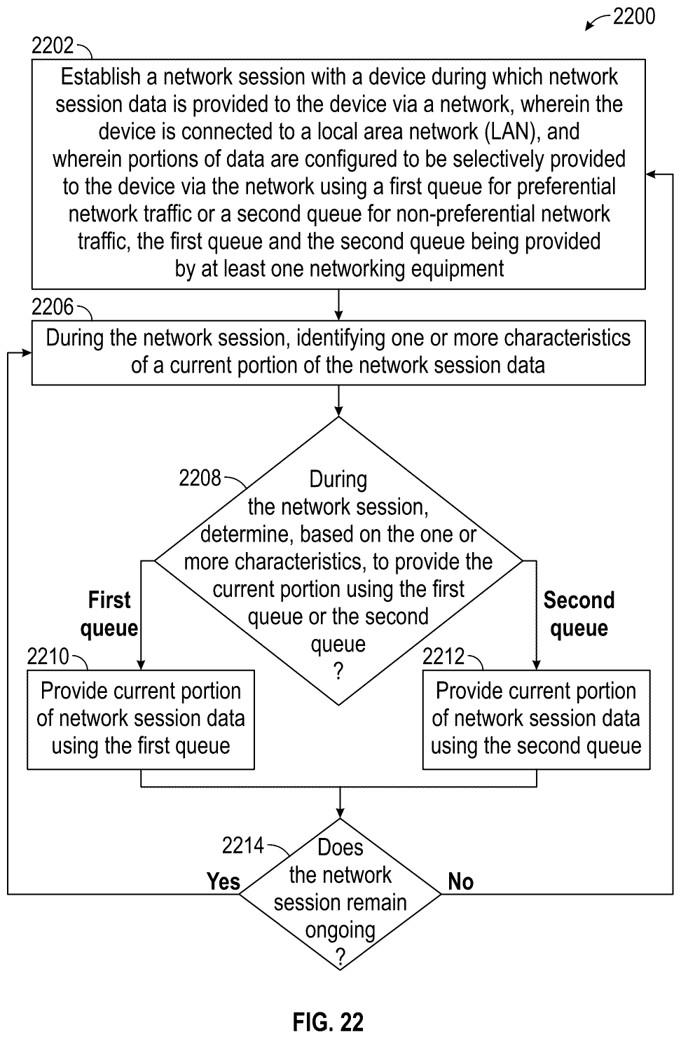

FIG. 22 is a flowchart of a detailed illustrative process 2200 for preferential treatment of portions of network traffic, in accordance with some embodiments of this disclosure. In various embodiments, the individual steps of process 2200 may be implemented by one or more components of the devices, methods, and systems of FIGS. 1-21 and may be performed in combination with any of the other processes and aspects described herein. Although the present disclosure may describe certain steps of process 2200 (and of other processes described herein) as being implemented by certain components of the devices, methods, and systems of FIGS. 1-21, this is for purposes of illustration only, and it should be understood that other components of the devices, methods, and systems of FIGS. 1-21 may implement those steps instead.

At 2202, control circuitry (e.g., control circuitry 2121 of FIG. 21 of LAN networking equipment 1115 and/or control circuitry 2131 of WAN networking equipment 2117 of FIG. 21) and/or I/O circuitry (e.g., 2121 of FIGS. 21 and/or 2132 of FIG. 21 of LAN networking equipment 2115 and WAN networking equipment 2117, respectively, of FIG. 21) and/or a network interface, may establish a network session with a device during which network session data is provided to the device via the network. For example, the control circuitry may provide the FPS video game 500 of FIG. 5 over the network to the user (e.g., user 110 of FIG. 1) of the device. The network session may last for any suitable period of time, e.g., a continuous period of time while user 110 of FIG. 1 is playing the video game online during a particular day. In some embodiments, the network may correspond to an LAN and/or WAN and/or any other suitable network (e.g., communications network 2109 of FIG. 21). In some embodiments, the network session may be established automatically or based on a request received from the device. Such request may be received from, for example, a device (e.g., device 112 or 114 of FIG. 1, an XR device, an autonomous cleaning or mowing device, a remote controller device, or any other suitable device, or any combination thereof). In some embodiments, the device may be connected to an LAN (e.g., a Wi-Fi network) at a particular location (e.g., location 104 of FIG. 1, which may be a home or residence of user 110 or any other suitable type of location). For example, router, modem, and/or gateway 106 and/or 108 may be used to provide such LAN, to enable devices 112 and 114 to connect to the Internet and access any suitable application or service (e.g., a video conference call via Zoom 118 or a “Call of Duty” video game online mode 116). At 2202, the control circuitry may, based on the request, establish a network session with the device during which network session data is provided to the device via the network. For example, the control circuitry may provide the FPS video game 500 over the network to the user (e.g., user 110 of FIG. 1) of the device. The network session may last for any suitable period of time, e.g., a continuous period of time while user 110 of FIG. 1 is playing the video game online during a particular day.

At 2202, the control circuitry (e.g., 212 of LAN networking equipment 2115 and/or 2131 of WAN networking equipment 2117) provides a first queue for preferential network traffic and a second queue for non-preferential traffic. For example, the first queue may comprise a buffer for a low latency service flow (e.g., 206, 210, 218 of FIGS. 2A-2B), such as, for example, for L4S-capable traffic, and the second queue may comprise a buffer for a classic service flow (e.g., service flow 206, 210, and/or 218 of FIGS. 2A-2B), such as, for example, for non-L4S-capable traffic.

At 2206, the control circuitry may, during the network session, identify one or more characteristics of a current portion of the network session data. For example, the control circuitry may perform analysis in real time or near real time to identify audio and/or visual characteristics of the current portion (e.g., portion 502 of video game 500). Additionally, or alternatively, the control circuitry may obtain and analyze metadata for the current portion of the network traffic, e.g., metadata indicating that portion 502 of FIG. 5 is a menu of the video game 500, metadata indicating that portion 504 is a combat portion of video game 500, and/or metadata indicating that portion 506 is an advertisement portion. As another example, such as during an XR session or an autonomous vehicle or robot, the control circuitry may determine characteristics of an environment surrounding the device or vehicle, e.g., a number of objects in a vicinity of a device or vehicle, a type of objects in the vicinity of the vehicle, weather conditions in the vicinity of the device or vehicle, whether the device or vehicle is indoors or outdoors, or any other suitable characteristics. For example, the device may use any suitable number of object detection techniques to identify number and/or types of objects, e.g., machine learning techniques and/or heuristic-based techniques.

At 2208, the control circuitry may, during the network session, determine, based on the one or more characteristics, to provide the current portion using the first queue or the second queue. For example, the control circuitry (e.g., 212 of LAN networking equipment 2115 and/or 2131 of WAN networking equipment 2117) may determine whether the first queue or the second queue (e.g., at WAN networking equipment 2117 and/or other suitable networking equipment) should be used for the current portion of network traffic. For example, the control circuitry may determine, at such networking equipment, whether the current portion of network traffic is intended for the first queue or the second queue enroute to its destination (e.g., device 112 or 114 of FIG. 1). Such determination may be based at least in part on whether the identified characteristic(s) at 2206 indicates that the current portion of the network session is latency sensitive (or not). In some embodiments, whether a portion of network traffic is latency sensitive depends on whether the portion of the data requires a threshold latency for an optimal quality of service. In the example of FIG. 5, the control circuitry may determine that, for the menu portion 502 of video game 500 and the cut scene portion 506, a relatively lower level of latency is acceptable, e.g., since menu 502 is not a core part of the gameplay, and that is would not significantly alter the gaming experience if input to switch to another menu option has a relatively higher latency, or that cut scene portion 506, or that cut scene portion 506 is prerecorded and does not require fast responses to user inputs or any responses to user inputs. In such a circumstance, processing may proceed to 2212. On the other hand, if the characteristic(s) identified at 2206 indicate that the current portion of network session data does require at least a threshold level of latency (and/or other network characteristics, such as, for example, bandwidth, jitter, RTT, or any other suitable characteristic to improve QoE), processing may proceed to 2210. For example, the control circuitry may determine that portion 504 or 508 is a current portion of the network session data being transmitted to the client device, and since such portions correspond to a FPS combat portion of video game 500 (e.g., as determined based on metadata and/or analysis of a current audio or visual portion of the transmitted data), at least a threshold level of latency is required for an optimal QoE.

As another example, the control circuitry may determine that the XR device (shown in FIG. 9) is outdoors (e.g., in an open field) and/or otherwise is not in the vicinity of any objects or less than a threshold number of objects and/or particular types of objects, and thus processing using the second queue may be suitable. On the other hand, the control circuitry may determine that the XR device (shown in FIG. 9) is indoors (e.g., in small room) and/or otherwise is in the vicinity of objects or more than a threshold number of objects and/or particular types of objects, and thus processing using the first queue may be optimal.

As another example, the control circuitry may determine that the an autonomous robot (shown in FIG. 11B) or a vehicle or construction equipment (shown in FIGS. 15A-15B) is not in the vicinity of any objects or less than a threshold number of objects and/or particular types of objects, and thus processing using the second queue may be suitable. On the other hand, the control circuitry may determine that the autonomous robot (shown in FIG. 11A) or a vehicle or construction equipment (shown in FIGS. 15A-15B) is in the vicinity of objects or more than a threshold number of objects and/or particular types of objects, and thus processing using the first queue may be optimal.

At 2210, the control circuitry may provide the current portion of network session data using the first queue (e.g., 206, 210 of FIG. 2A or 218 of FIG. 2B) for L4S network traffic, and/or any other suitable mechanism for treating network traffic preferentially. For example, the control circuitry may transmit, at the networking equipment (e.g., networking equipment 2115 and/or 2117) a current portion of the network session data intended for the first queue. On the other hand, at 2212, the control circuitry may provide the current portion of network session data using the second queue (e.g., 208, 212 of FIG. 2A or 2220 of FIG. 2B) for non-L4S network traffic, and/or any other suitable mechanism for treating network traffic non-preferentially. For example, the control circuitry may transmit, at the networking equipment (e.g., networking equipment 2115 and/or 2117) a current portion of the network session data intended for the second queue.

At 2214, the control circuitry may determine whether the network session (established at 2202) remains ongoing. For example, the control circuitry may determine whether a next portion of data transmitted to the client device (or other client device on the LAN of FIG. 1) is associated with a same application service provider as the previous portion(s) of data, and if so, processing may proceed to 2206. If a next portion of data transmitted to a client device (or other client device on the LAN of FIG. 1) is related to a different application service, processing may return to 2202.

In some embodiments, the process of FIG. 22 may be performed simultaneously or in parallel for multiple types of network traffic requested by devices on the LAN. In some embodiments, as part of the process of FIG. 22, the control circuitry may determine whether a particular network traffic data cap has been reached, e.g., per application or per device. For example, the LAN at location 104 may be associated with a data cap for network traffic categorized for gaming, either as specified by user 110 or as specified by service provider network 102 of FIG. 1. If a data cap is reached for a particular device or application, network traffic may be provided using the second, non-preferential network traffic queue.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
establishing a network session with a device during which network session data is provided to the device via a network, wherein the device is connected to a local area network (LAN), and wherein portions of data are configured to be selectively provided to the device via the network using a first queue for preferential network traffic or a second queue for non-preferential network traffic, the first queue and the second queue being provided by at least one networking equipment;
during the network session:
identifying one or more characteristics of a portion of the network session data;
determining, based on the one or more characteristics of the portion of the network session data, whether to provide the portion of the network session data to the device using the first queue for preferential network traffic or the second queue for non-preferential network traffic; and
based on determining to provide the portion of the network session data using the first queue for preferential network traffic, providing the portion of the network session data to the device using the first queue for preferential network traffic.

2. The method of claim 1, wherein:
identifying the one or more characteristics of the portion of the network session data comprises determining whether the portion of the network session data is latency sensitive;
determining whether to provide the portion of the network session data to the device using the first queue for preferential network traffic or the second queue for non-preferential network traffic is based on whether the portion of the network session data is latency sensitive; and
based on determining that the portion of the network session data is latency sensitive, providing the portion of the network session data to the device using the first queue for preferential network traffic.

3. The method of claim 2, wherein:
the network session comprises a video gaming session and the network session data comprises data for a video game played by a user of the device during the video gaming session; and
determining whether the portion of the network session data is latency sensitive comprises determining whether the portion of the network session data corresponds to one or more characters within the video game being controlled by the user or to a cutscene or menu screen of the video game.

4. The method of claim 3, wherein determining whether the portion of the network session data is latency sensitive is further based at least in part on at least one of a type of the video game or a type of a video game portion in which the one or more characters are being controlled by the user.

5. The method of claim 3, wherein the determining whether the portion of the network session data is latency sensitive is based at least in part on identifying metadata associated with the video game and determining whether the metadata indicates that the portion of the network session data is latency sensitive.

6. The method of claim 5, wherein the metadata is received via an API call.

7. The method of claim 2, wherein:
determining whether to provide the portion of the network session data to the device using the first queue for preferential network traffic or the second queue for non-preferential network traffic based at least in part on a bandwidth of the network and a jitter associated with providing the portion of the network session data over the network.

8. The method of claim 1, wherein:
the network session data is provided by an application service provider during the network session, and the portion of the network session data is a first portion;
the method further comprising:
identifying one or more characteristics of a second portion of the network session data;
determining, based on the one or more characteristics of the second portion of the network session data, whether to provide the second portion of the network session data to the device using the first queue for preferential network traffic or the second queue for non-preferential network traffic; and
based on determining to provide the second portion of the network session data using the second queue for non-preferential network traffic, providing the second portion of the network session data to the device using the second queue for non-preferential network traffic.

9. The method of claim 1, wherein:
identifying the one or more characteristics of the portion of the network session data comprises determining a threshold level of localization accuracy or a threshold level of localization precision required for the portion of the network session data; and
determining to provide the portion of the network session data using the first queue for preferential network traffic based on determining the localization accuracy required for the portion of the network session data exceeds the threshold level of localization accuracy or the localization precision required for the portion of the network session data exceeds the threshold level of precision.

10. The method of claim 9, wherein determining the localization accuracy required for the portion of the network session data exceeds the threshold level of localization accuracy or the localization precision required for the portion of the network session data exceeds the threshold level of precision based on at least one of a proximity of the device to one or more objects in an environment of the device or a speed of the device.

11. The method of claim 10, wherein the device is an extended reality (XR) device, and the method further comprises:
causing data transmitted by the XR device to be provided to a remote server using the first queue for preferential network traffic, based at least in part on the determining that the localization accuracy required for the portion of the network session data exceeds the threshold level of localization accuracy or the localization precision required for the portion of the network session data exceeds the threshold level of precision.

12. The method of claim 1, wherein the device is an extended reality (XR) device, and causing data transmitted by the device to be provided to a remote server using the first queue for preferential network traffic is further based on determining whether one or more virtual objects rendered by the XR device are within a threshold distance of a physical object in an environment surrounding the XR device.

13. The method of claim 1, wherein the device is a robotic device, and the method further comprises causing data transmitted by the device to be provided to a remote server using the first queue for preferential network traffic is based on determining whether one or more objects are within a threshold distance of the robotic device.

14. The method of claim 1, further comprising, based on determining to provide the portion of the network session data using the first queue for preferential network traffic, causing bits of the portion of the network session data to be marked with an indication that the portion of the network session data is to be provided to the device using the first queue for preferential network traffic.

15. The method of claim 1, wherein the first queue for the preferential network traffic is for low latency, low loss, and scalable throughput (L4S) network traffic.

16. The method of claim 1, wherein:
the network session comprises a multiplayer video gaming session in which users are playing a video game with each other over the network via a plurality of devices, wherein the plurality of devices include the device and one or more other devices;
the one or more other devices are remote from the device of the LAN; and
the method further comprises, based on determining that a particular device of the one or more other devices is not capable of receiving or processing preferential network traffic over the network using the first queue for preferential network traffic, providing data to each of the plurality of devices using the second queue for non-preferential network traffic for a remainder of the network session.

17. The method of claim 16, wherein determining that the particular device of the other devices is not capable of receiving or processing preferential network traffic over the network using the first queue for preferential network traffic comprises analyzing a network packet received from the particular device.

18. The method of claim 1, wherein the device is associated with a controller, and the method further comprises:
causing network session data, corresponding to input received via the controller in relation to the portion of the network session data, to be processed using the first queue for preferential network traffic.

19. A system comprising:
control circuitry configured to:
establish a network session with a device during which network session data is provided to the device via a network, wherein the device is connected to a local area network (LAN), and wherein portions of data are configured to be selectively provided to the device via the network using a first queue for preferential network traffic or a second queue for non-preferential network traffic, the first queue and the second queue being provided by at least one networking equipment;
during the network session:
identify one or more characteristics of a portion of the network session data;
determine, based on the one or more characteristics of the portion of the network session data, whether to provide the portion of the network session data to the device using the first queue for preferential network traffic or the second queue for non-preferential network traffic; and
based on determining to provide the portion of the network session data using the first queue for preferential network traffic, provide the portion of the network session data to the device using the first queue for preferential network traffic.

20. The system of claim 19, wherein:
the control circuitry is configured to identify the one or more characteristics of the portion of the network session data by determining whether the portion of the network session data is latency sensitive;
the control circuitry is configured to determine whether to provide the portion of the network session data to the device using the first queue for preferential network traffic or the second queue for non-preferential network traffic based on whether the portion of the network session data is latency sensitive; and
the control circuitry is configured to, based on determining that the portion of the network session data is latency sensitive, provide the portion of the network session data to the device using the first queue for preferential network traffic.

21-90. (canceled)
